(19) United States
(12) Patent Application Publication
(10) Pub. No.: US 2019/0050530 A1
(43) Pub. Date: Feb. 14, 2019

(54) Systems and Methods for Analyzing Nucleic Acids

(71) Applicant: Toma Biosciences, Inc., Foster City, CA (US)

(72) Inventor: Francisco De La Vega, San Mateo, CA (US)

(73) Assignee: Toma Biosciences, Inc., Foster City, CA (US)

(21) Appl. No.: 16/075,549

(22) PCT Filed: Feb. 9, 2017
(86) PCT No.: PCT/US17/17230

§ 371 Date: Aug. 3, 2018

Related U.S. Application Data
(60) Provisional application No. 62/293,136, filed on Feb. 9, 2016.

(51) Int. Cl. G06F 19/22; G06F 19/18; G06F 19/24; G06F 19/20

(52) U.S. Cl. CPC G06F 19/22; G06F 19/20; G06F 19/24; G06F 19/18

(57) ABSTRACT

Provided herein are systems, software media, networks, kits, and methods for performing computational analyses on sequencing data of samples from an individual. An analysis can extract germline and somatic information and compare both types of information to identify sequence variants based on probabilistic modeling and statistical inferences. The analysis can comprise distinguishing between germline variants, e.g., private variants, and somatic mutations. The identified variants can be used by clinics to provide better health care.

### CROSS-REFERENCE

This application is a 371 filing of International Application PCT/US2017/017230 filed on Feb. 9, 2017, which claims the benefit of U.S. Patent Application Ser. No. 62/293,136 filed Feb. 9, 2016, all of which are incorporated herein by reference in their entirety.

### BACKGROUND

Accurately identifying cancer somatic mutations from high throughput sequencing data of tissue samples can be a challenging and an unsolved problem. Sequencing data can be used in clinical procedures for therapy selection with unknown analytic rates of false positive or negative variants. Among the issues that can be faced in this process include: heterogeneity of the tissue sample due to the presence of normal cells at a wide range of different proportions depending on the sample (e.g., primary tumor vs. cell-free DNA (cf-DNA) in plasma), the presence of multiple clones of cancer cells at different proportions, the lack of data from a sample from “normal” tissue to enable the differentiation between somatic and germline variants, the damage inflicted to DNA in the sample due to pathology processing (e.g., formalin-fixation and paraffin embedding (FFPE)), and the convolution of structural variations with simple sequence variants. New analysis methods can improve germline variant identification from large-scale sequencing data.

In some cases, cancer data analysis can produce inconsistent results when the data in the analysis is compared with a single control sample. In some cases, the data analysis relies on the availability of data from normal tissue of the patient processed in similar fashion as a sample containing, or suspected of containing a cancer cell, which often is not available in cancer pathology use cases. Current analysis pipelines that include manual or heuristic methods to filter out germline variants from somatic mutations can be arbitrary, imprecise, difficult to reproduce, and not provide information about the trade-off between false positives and false negatives tacitly made in the process. When a normal tissue is available, however, in some cases it is analyzed independently and only brought together as a filtering step after decisions have been made on “real” germline variants, which can result in false positive somatic mutation calls due to germline variants that missed the threshold imposed in germline calling. A solution to deal with the later issues can be to use panels of normal samples as reference germline variants common in the population. To further deal with rare variants present in the patient, including cancer susceptibility variants, new methods are disclosed herein. The methods can be based on simultaneously calling and scoring variants from aligned sequencing data of all samples obtained from the patient, as well as a set of other previously analyzed patients.

### SUMMARY

Provided herein are systems, software media, networks, and methods for identifying cancer somatic mutations from high throughput sequencing data of tissue.

In one aspect, disclosed herein is a computing system comprising: (a) a processor, and a memory module configured to execute machine readable instructions; and (b) a data analysis application comprising: (1) a data receiving module configured to receive sequence reads of nucleic acid molecules from one or more samples of an individual, wherein the sequence reads are generated by a high-throughput sequencing instrument; (2) a sequence alignment module configured to align the sequence reads with respect to a reference assembly to generate predicted genomic sequences; and (3) a genomic analysis module configured to (i) identify a putative variant by analyzing jointly and simultaneously the predicted genomic sequences, and (ii) score the putative variant by a probability of being a somatic mutation or a germline variant.

In another aspect, disclosed herein is computer-readable storage media encoded with a computer program including instructions executable by a processor to create a data analysis application, the application comprising: (a) a data receiving module configured to receive sequence reads of nucleic acid molecules from one or more samples of an individual, wherein the sequence reads are generated by a high-throughput sequencing instrument; (b) a sequence alignment module configured to align the sequence reads with respect to a reference assembly to generate predicted genomic sequences; and (c) a genomic analysis module configured to (i) identify a putative variant by analyzing jointly and simultaneously the predicted genomic sequences, and (ii) score the putative variant by a probability of being a somatic mutation or a germline variant.

In another aspect, disclosed is a method comprising: (a) collecting one or more samples of an individual; (b) using a high-throughput sequencing instrument to sequence nucleic acid molecules of the one or more samples and generate sequence reads; (c) aligning the sequence reads to a reference assembly to generate predicted genomic sequences; (d) identifying a putative variant by analyzing jointly and simultaneously the predicted genomic sequences; and (e) scoring the putative variant by a probability of being a somatic mutation or a germline variant.

In various embodiments, the systems, software media, methods, disclosed herein, or use thereof, include use of one or more samples. The one or more samples can be collected at a same time. In some cases, the one or more samples comprise at least two samples, and the at least two samples can be collected at different times. In certain applications, the one or more samples may comprise one or more of the following: a primary tumor, a metastatic tumor, a bodily fluid, a cell-free sample, a lymphocyte, and plasma.

In various disclosed systems, software media and methods disclosed herein, identifying a putative variant can comprise comparing the genomic sequences to sequences of a bank of sequences from one or more previously analyzed patients. Scoring a putative variant can comprise adjusting a probability based on a machine learning method trained with sets of good calls and bad calls. Identifying and scoring a putative variant can comprise making an inference at a chromosomal locus.

In various applications, making an inference can comprise using one or more of the following: a probabilistic model, a statistical inference, a Bayesian inference, and a Bayesian network model. In some designs, making an inference can be based on one or more of the following: a prior probability of finding germline and somatic variants, a set of sequence reads aligned across the chromosomal locus, an error rate of the high-throughput sequencing instrument, a ploidy of a chromosomal region covering the chromosomal locus, a process model of cancer clonal evolution, a call at the chromosomal locus derived from one or more other samples of the individual, a call at the chromosomal locus derived from one or more samples of one or more other individuals, prior knowledge of a common polymorphism at the chromosomal locus in one or more reference populations, prior knowledge of one or more recurrent cancer mutations at the chromosomal locus, a percentage of cancer cells in a sample containing a cancer, describing a variant by a probabilistic model, describing a set of aligned sequence reads across the chromosomal locus by a probabilistic model, describing a ploidy at the chromosomal locus by a probabilistic model, and describing a percentage of cancer cells in a sample by a probabilistic model.

In some designs, an error rate can be provided in quality validation for a base call. A cancer containing sample can comprise one or more DNA molecules causing the cancer, or one or more cancerous tissues, or both. A percentage used herein can be described by a binary variable.

In various disclosed systems, software media and methods disclosed herein, a data analysis application can further comprise a module configured to annotate a putative variant with respect to an impact in one or more of the following: one or more coding regions, a predicted damage severity, one or more germline mutations, one or more somatic mutations, one or more mutation-drug interactions, one or more observed mutations in clinical trials, one or more diseases, one or more syndromes, or one or more side effects.

In various disclosed systems, software media and methods disclosed herein, a data analysis application can comprise a module configured to recommend a therapy method, or a treatment method, or both.

In various disclosed systems, software media and methods disclosed herein, a data analysis application can comprise a module configured to assess a treatment progress.

In various disclosed systems, software media and methods disclosed herein, a data analysis application can comprise a module configured to assess a risk.

In various disclosed systems, software media and methods disclosed herein, a data analysis application can comprise a module configured to monitor efficacy of a therapy method, or a treatment method, or both.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a method disclosed herein.

FIG. 2 illustrates an example of a data receiving module.

FIG. 3 illustrates an example of a sequence alignment module.

FIG. 4 illustrates an example of a genomic analysis module.

FIG. 5 illustrates an example of analyzing sequences at a chromosomal locus.

FIG. 6 illustrates an example of using different types of samples from a subject to evaluate a probability of a putative variant.

FIG. 7 illustrates an example of using information around a locus to evaluating a probability of a putative variant.

FIG. 8 illustrates a Bayesian network diagram for joint inference of cancer somatic mutations.

FIG. 9 illustrates a computer control system for performing an analysis disclosed herein.

FIG. 10 depicts an exemplary workflow for a method of preparing a DNA library, e.g., from a tumor sample of a subject.

### DETAILED DESCRIPTION OF THE INVENTION

### I. Overview

The technologies disclosed herein can be directed to computational analysis on high throughput nucleic acid sequencing data of samples from an individual. An analysis can extract germline and somatic information and compare both types of information to identify sequence variants based on probabilistic modeling and statistical inferences. Germline variants refer to nucleic acids inducing natural or normal variations (e.g., skin colors, hair colors, and normal weights). Somatic mutations refer to nucleic acids inducing acquired or abnormal variations (e.g., cancers, obesity, symptoms, diseases, disorders, etc.). The analysis can comprise distinguishing between germline variants, e.g., private variants, and somatic mutations. The identified variants can be used by clinics to provide better health care.

Provided herein are improved methods, computing systems or software media that can distinguish among sequence errors in nucleic acid introduced through amplification and/or sequencing techniques, somatic mutations and germline variants. Methods are provided comprising simultaneously calling and scoring variants aligned from aligned sequencing data of all samples obtained from a patient. Samples from other subjects, e.g., samples from other subjects previously analyzed by a sequencing assay, e.g., a targeted sequencing assay, e.g., a targeted resequencing assay, can be used. Use of the improved methods, computing systems, or software media can be result in better discrimination of germline and somatic mutations (e.g., less false positives) and lower limits of detection (e.g., less false negatives).

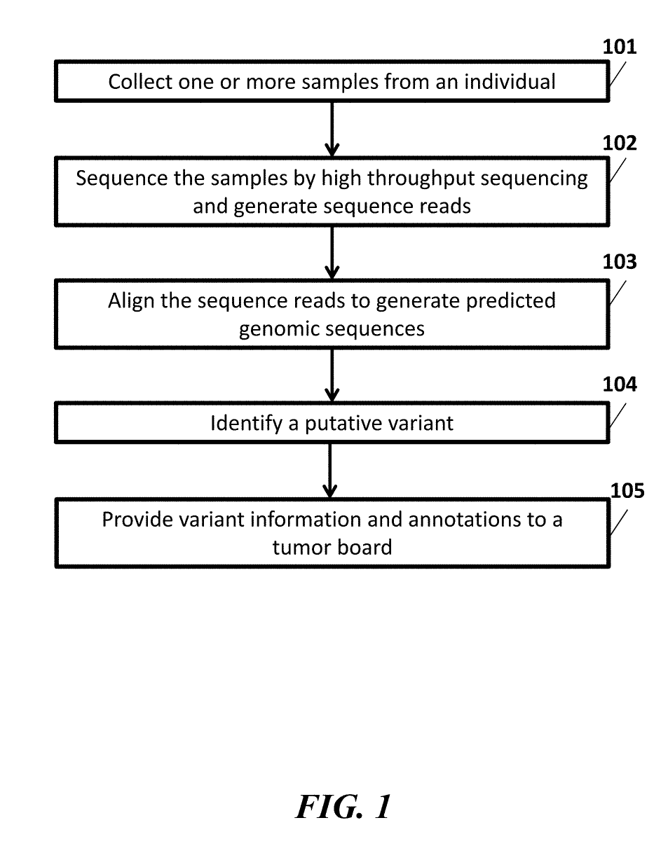

FIG. 1 illustrates an overview of a method provided herein. In step 101, a system or a method comprises collecting one or more samples of an individual. A sample can be obtained, e.g, from a tissue or a bodily fluid or both, from an individual, e.g., a subject, a patient. The sample can be any sample described herein, e.g., a primary tumor, metastasis tumor, buffy coat from blood (e.g., lymphocytes), or cell-free DNA (cf-DNA) extracted from plasma. In step 102, nucleic acid molecules in one or more samples can be sequenced, e.g., by a high-throughput sequencing instrument. One or more sequencing libraries can be prepared, e.g., by any method described herein. A sequencing library can be prepared for each tissue sample and/or for samples obtained at different time points. The sequencing results can generate sequence reads. To assemble the sequence reads into a predicted genome of the individual, step 103 aligns the sequence reads with respect to a reference assembly, e.g., a human reference assembly, to generate predicted genomic sequences. In step 104, the system or the method identifies a putative variant. The identification can comprise jointly and simultaneously analyzing the predicted genomic sequences and scoring the putative variant by a probability of being a somatic mutation or a germline variant. Cellularity estimates, as described herein, of the samples can be used to inform the scoring. Variants can be rescored, e.g., based on a machine learning method trained with sets of good (i.e., true positives) and bad (i.e., false positives) calls. Variants can be annotated with respect to their impact in coding regions, predicted damage severity, cross reference to other databases of germline and somatic mutations, mutations-drug interactions, clinical trials accepting patients with observed mutations, or other medically relevant knowledge bases. In step 105, variant information and annotations, e.g., evidence for absence of variation across cancer genes and relevant hotspots, can be provided to a tumor board to enable the tumor board to make a therapy recommendation for the individual or to assess treatment progress or possible relapse.

Also provided herein is a computing system comprising a processor, and a memory module configured to execute machine readable instructions; and a data analysis application comprising a data receiving module configured to receive sequence reads of nucleic acid molecules from one or more samples of an individual, wherein the sequence reads are generated by a high-throughput sequencing instrument; a sequence alignment module configured to align the sequence reads with respect to a reference assembly to generate genomic sequences; and a genomic analysis module configured to (i) identify a putative variant by analyzing jointly and simultaneously the genomic sequences, and (ii) score the putative variant by a probability of being a somatic mutation or a germline variant.

Also provided herein is a computer-readable storage media encoded with a computer program including instructions executable by a processor to create a data analysis application, the application comprising a data receiving module configured to receive sequence reads of nucleic acid molecules from one or more samples of an individual, wherein the sequence reads are generated by a high-throughput sequencing instrument; a sequence alignment module configured to align the sequence reads with respect to a reference assembly to generate genomic sequences; and a genomic analysis module configured to (i) identify a putative variant by analyzing jointly and simultaneously the genomic sequences, and (ii) score the putative variant by a probability of being a somatic mutation or a germline variant.

Also provided herein is a method comprising collecting one or more samples of an individual; using a high-throughput sequencing instrument to sequence nucleic acid molecules of the one or more samples and generate sequence reads; aligning the sequence reads to a reference assembly to generate genomic sequences; identifying a putative variant by analyzing jointly and simultaneously the genomic sequences; and scoring the putative variant by a probability of being a somatic mutation or a germline variant.

### II. Data Analysis Application

The methods, computer systems, or computer readable media provided herein can include one or more data analysis applications. A data analysis application can comprise several modules with different functions. For example, a data analysis application can comprise a data receiving module to receive sequence reads. A data analysis application can comprise a sequence alignment module which can take the sequence reads and align the sequence reads to generate predicted genomic sequences. A data analysis application can comprise a genomic analysis module which can take the predicted genomic sequences and perform probabilistic and statistical analysis to identify putative genetic variant causing a disease.

### A. Data Receiving Module

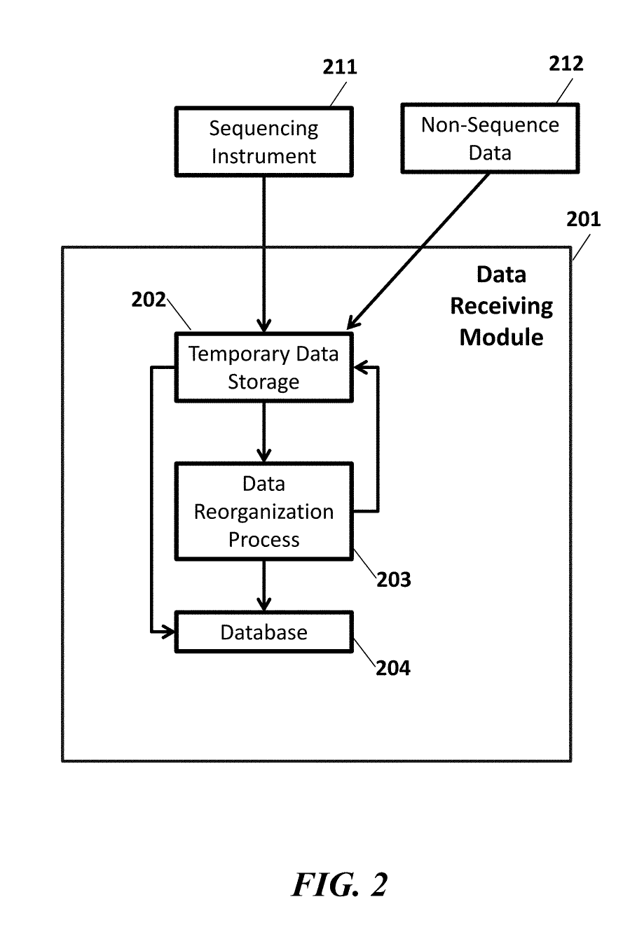

FIG. 2 illustrates an example of a data receiving module. A data receiving module 201 can comprise a temporary data storage 202, such as a memory device or a hard drive, to store the sequence reads generated by a sequencing instrument, e.g., a high-throughput sequencing instrument 211. Non-sequence data 212 can be provided to the data receiving module 201. Examples of non-sequence data 212 include, but are not limited to, names, dates of birth, genders, demographics, medical history, familial information, sample sources, sample collection times, and sample biological conditions. A data receiving module can receive sequence read data from at least 1, 2, 3, 4, 5, 10, 20, or more samples from a subject. A data receiving module can receive sequence data from at least 1, 2, 3, 4, 5, 10, 20, or more different subjects.

A data receiving module can comprise a data reorganization process 203. A reorganization process 203 can reorganize temporarily stored data into a predefined format and store the reorganized data in a database 204. For example, sequence reads of multiple subjects can be separated by individual subject. In another example, sequence reads can be reorganized based on annotated information. In some embodiments, for example, when sequence data and non-sequence data cannot be paired, the data reorganization process 203 can return both data back to the temporary data storage to wait more upcoming data, or the data reorganization process 203 can mark the missing data entries and store the reorganized data into a database 204.

### B. Sequence Alignment Module

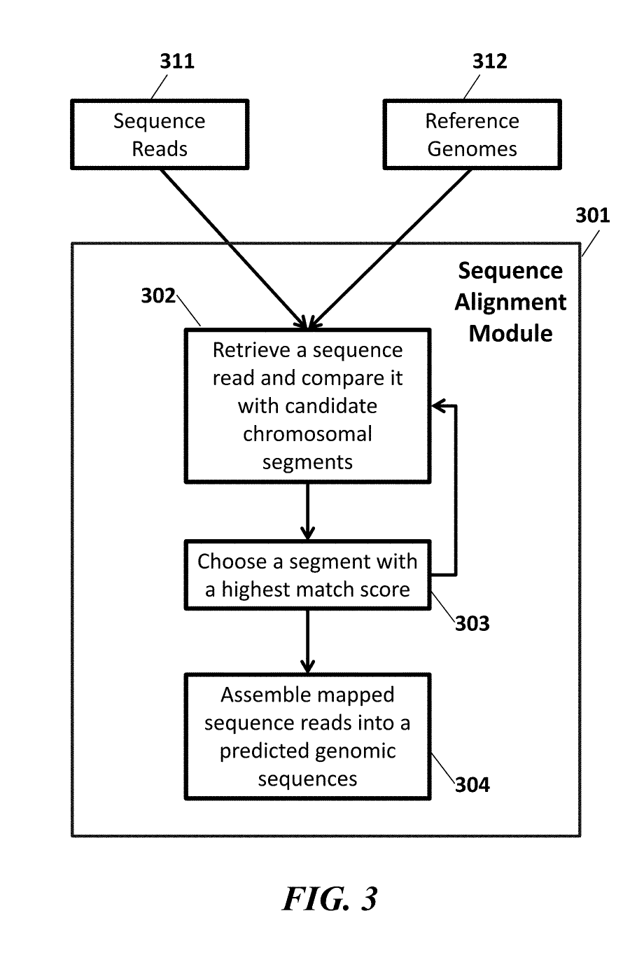

FIG. 3 illustrates an example of a sequence alignment module. Operation of a sequence alignment module can comprise three steps. The module can access sequence reads 311 from a data receiving module. The module can also access one or more reference genomes 312 for the purpose of alignment. The first step 302 can retrieve a sequence read and compare the sequence read with a plurality of candidate chromosomal segments. A “plurality” can contain at least 2 members. In certain cases, a plurality can have at least 10, at least 100, at least 100, at least 10,000, at least 100,000, at least 1,000,000, at least 10,000,000, at least 100,000,000, or at least 1,000,000,000 or more members. The comparison can be based on a statistical analysis. In second step 303, the sequence alignment module can choose a genomic segment with a highest matching score. The steps 302 and 303 can be repeated for each sequence read. The last step 304 can assemble and aggregate all the sequence reads into predicted genomic sequences of the individual, e.g., once all the sequence reads are mapped to a reference genome.

A genomic sequence as used herein can refer to a sequence that occurs in a genome. Because RNAs are transcribed from a genome, this term can encompass sequence that exists in the nuclear genome of an organism, as well as sequences that are present in a cDNA copy of an RNA (e.g., an mRNA) transcribed from such a genome.

A predicted genomic sequence as used herein can refer to a genomic sequence assembled by a sequence alignment module.

In the process of sample preparation and sequencing, partial or complete sequencing of nucleic acid, e.g., DNA, fragments present in the sample can be performed. Sequence tags comprising reads that map to a known reference genome can be counted. In some cases, only sequence reads that uniquely align to the reference genome can be counted as sequence tags. In some embodiments, the reference genome is the human reference genome NCBI36/hg18 sequence, which is available on the world wide web at genome.ucsc.edu/cgi-bin/hgGateway?org=Human&db=hg18&hgsid=166260105. Other sources of public sequence information include GenBank, dbEST, dbSTS, EMBL (the European Molecular Biology Laboratory), and the DDBJ (the DNA Databank of Japan). The reference genome can also comprise the human reference genome NCBI36/hgl 8 sequence and an artificial target sequences genome, which includes polymorphic target sequences. In some embodiments, the reference genome is an artificial target sequence genome comprising polymorphic target sequences. The reference genome can be a public human genome (e.g., hg18, hg19, or hg37).

In some cases, the reference genome is from a subject, or group of subjects, that has/have the same disease (e.g., cancer), age, ethnicity, gender, nationality, occupation, exposure (e.g., to a toxin, radiation, or biological agent), or residence (e.g., same home, city, state, country, or continent) as the subject whose sample is being evaluated. In some cases, the reference genome is from a subject, or group of subjects, that has/have a different disease (e.g., cancer), age, ethnicity, gender, nationality, occupation, exposure (e.g., to a toxin, radiation, or biological agent), or residence (e.g., same home, city, state, country, or continent) as the subject whose sample is being evaluated. The reference genome can be from one or more relatives (e.g., father, mother, sibling, cousin, or grandparent) of the subject whose sample is being evaluated. In some cases, the reference genome is not from a relative (e.g., father, mother, sibling, cousin, or grandparent) of the subject who is being evaluated.

Mapping of the sequence tags can be achieved by comparing the sequence of the tag with the sequence of the reference genome to determine the chromosomal origin of the sequenced nucleic acid (e.g., cell free DNA) molecule. A number of computer algorithms are available for aligning sequences, including without limitation BLAST (Altschul et al., 1990), BLITZ (MPsrch) (Sturrock & Collins, 1993), FASTA (Person & Lipman, 1988), BOWTIE (Langmead et al, Genome Biology 10:R25.1-R25.10 [2009]), or ELAND (Illumina, Inc., San Diego, Calif., USA). In one embodiment, a nucleic acid molecule can be clonally expanded, and one end of the clonally expanded copies of the DNA molecule is sequenced and processed by bioinformatics alignment analysis for the Illumina Genome Analyzer, which can use the Efficient Large-Scale Alignment of Nucleotide Databases (ELAND) software. Additional software includes SAMtools (SAMtools, Bioinformatics, 2009, 25(16):2078-9), and the Burroughs-Wheeler block sorting compression procedure which can involve block sorting or preprocessing to make compression more efficient. The sequence alignment tool can be Artemis Comparison Tool (ACT), AVID, BWA-MEM, BLAT, DECIPHER, GMAP, Splign, Mauve, MGA, Mulan, Multiz, PLAST-ncRNA, Sequerome, Sequilab, Shuffle-LAGEN, SIBsim4, or SLAM. A sequence alignment tool can be a short-read sequence alignment tool, e.g., BarraCUDA, BBMap, BFAST, BigBWA, BLASTN, BLAT, or Bowtie.

### C. Genomic Analysis Module

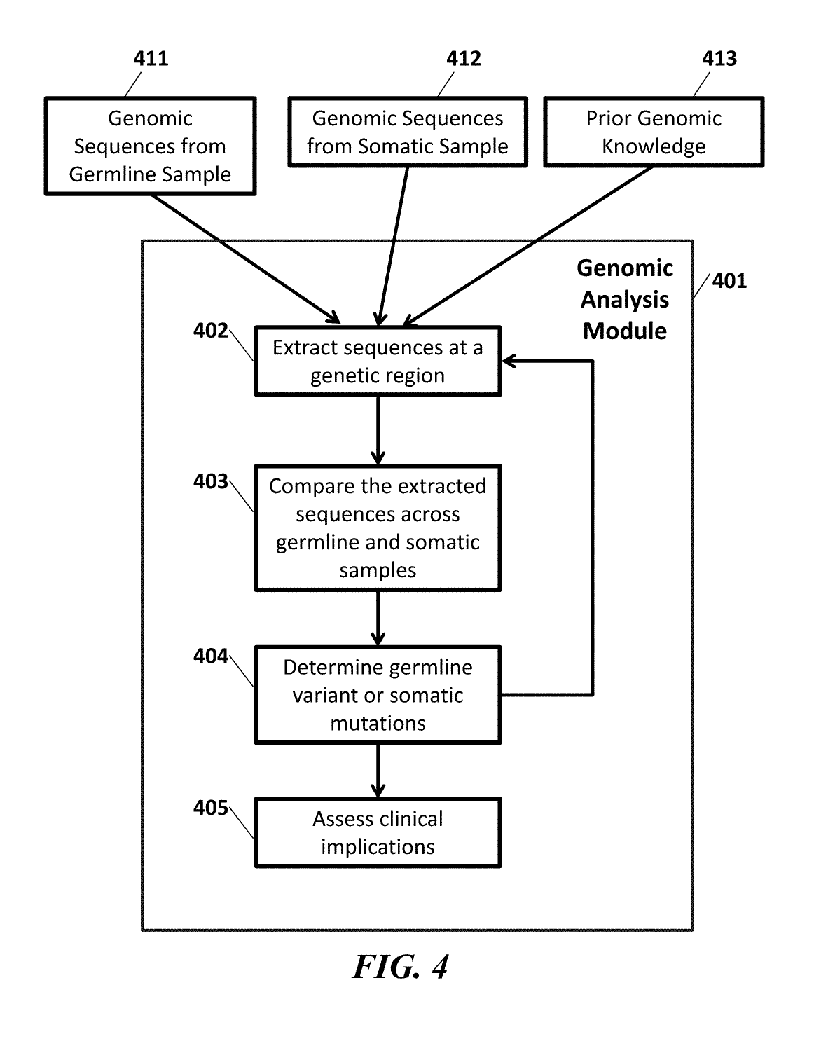

FIG. 4 illustrates an example of a genomic alignment module. Input of a genomic analysis module can be genomic sequences from one or more germline samples 411, genomic sequence from one or more somatic samples 412, and prior genomic knowledge 413. A germline sample can include a bodily fluid such as peripheral blood. A somatic sample can include tumor tissue. Prior genomic knowledge 413 can include information from databases of published scientific documents, or information from databases of genomic annotations, or information from databases of previously analyzed samples from the same subject or from different subjects, or information from a combination of the databases thereof.

A genomic analysis module can identify one or more putative variants by comparing the genomic sequences to sequences in a bank of sequences from one or more previously analyzed patients. The module can perform four steps. The first step 402 can involve extracting genomic sequences of a genetic region, where the sequences are from different samples. Step 403 can compare the extracted sequences across germline and somatic samples, where the comparison can be based on probabilistic and statistical methods. Step 404 can determine one or more putative variants; a putative variant can be a germline variant or a somatic mutation. The steps 402, 403 and 404 can be repeated over all the genetic regions of interest. Step 405 can assess clinical implications of the one or more putative variants.

A genetic region can comprise one or more chromosomal loci. A genetic region can be a continuous region on a chromosome. A genetic region can be a collection of two or more discrete chromosomal regions. A genetic region can be on a single chromosome. In some cases, a genetic region can be on two or more chromosomes. In some embodiments, a generic region can be one or more base pairs.

Comparing sequences across germline and somatic samples and determining one or more putative variants can be based on scoring the putative variants by a probability of being a somatic mutation or a germline variant. Scoring the putative variants can comprise adjusting the probability based on a machine learning method trained with sets of good calls (i.e. true positives) and bad calls (i.e. false positives).

### D. Making an Inference at a Chromosomal Locus or in a Genetic Region

Identifying and scoring putative variants can comprise making an inference at a chromosomal locus or in a genetic region. Making an inference can comprise using a probabilistic model and/or a statistical inference. Examples of probabilistic models and statistical inferences include, but not limited to, Bayesian inferences and Bayesian network models. Making an inference can be based on a prior probability of finding germline and somatic variants derived from prior genomic knowledge 413.

The term “locus” can refer to a location of a gene, nucleotide, or sequence on a chromosome. An “allele” of a locus can refer to an alternative form of a nucleotide or sequence at the locus. A “wild-type allele” can refer to an allele that has the highest frequency in a population of subjects. In some cases, a “wild-type” allele is not associated with a disease. A “mutant allele” can refer to an allele that has a lower frequency that a “wild-type allele” and can be associated with a disease. In some cases, a “mutant allele” is not associated with a disease. The term “interrogated allele” can refer to the allele that an assay is designed to detect. The term “single nucleotide polymorphism”, or “SNP”, can refer to a type of genomic sequence variation resulting from a single nucleotide substitution within a sequence. “SNP alleles” or “alleles of a SNP” can refer to alternative forms of the SNP at particular locus. The term “interrogated SNP allele” can refer to the SNP allele that an assay is designed to detect.

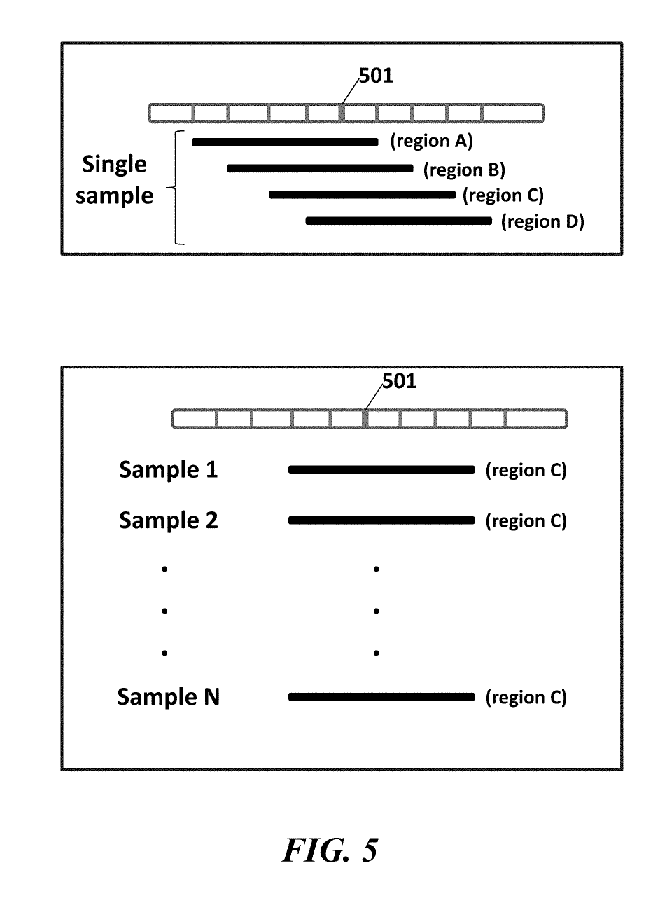

Making an inference can be based on a set of multiple sequences across a chromosomal locus. With reference to FIG. 5, a chromosomal locus 501 is of interest. Multiple sequences can be from a single sample, and they can be collected from multiple regions A, B, C, and D covering the locus 501. Multiple sequences can be from multiple samples 1, 2, . . . N, and they can be collected from an identical region C covering the locus 501.

Making an inference can be based on an error rate of a high-throughput sequencing instrument. An error rate can be provided in quality validation for a base call. In some examples, making an inference can be based on a ploidy of a chromosomal region covering a chromosomal locus. An abnormal ploidy may be associated with a somatic mutation or a germline variation.

Making an inference can be based on a process model of cancer clonal evolution. A process may be modeled by a Markov chain where a second state is predicted or inferred from a first state. For instance, a time of evolution from a cancer stage to another cancer stage; a size of a tumor tissue as the tumor evolves over time; a metastasis process from a primary organ to another remote organ; a cancer growing process with accompanying symptoms taking place in an early stage and in a later stage.

Making an inference can be based on a call at a chromosomal locus derived from one or more other samples of the individual. With reference to FIG. 5, samples 1, 2, . . . N can be collected from a single tumor tissue of an individual, and a nucleic acid call of locus 501 can be based on evaluating calls of germline variations or somatic mutations from analyzing all available samples or part of available samples.

Making an inference can be based on a call at a chromosomal locus derived from one or more samples of one or more other individuals. With reference to FIG. 5, samples 1, 2, . . . N can be collected from two or more individuals, and a nucleic acid call of locus 501 can be based on evaluating calls of germline variations or somatic mutations from analyzing all available samples or part of available samples.

Making an inference can be based on prior knowledge of a common polymorphism at the chromosomal locus in one or more reference populations. Referring to FIG. 5, the chromosomal locus 501 can be a known cancer causing polymorphism in prior genomic knowledge; e.g., prior knowledge shows one or more recurrent cancer mutations at the chromosomal locus 501.

Making an inference can be based on a cellularity estimate on the percentage of cancer cells in a sample. Cellularity can be the fraction of nucleic acids in a sample derived from a tumor.

Making an inference can be based on one or more probabilistic models. Probabilistic models can be used to describe a set of aligned sequence reads across the chromosomal locus, a ploidy at the chromosomal locus, or the percentage of cancer cells in a sample. Probabilistic models can include continuous models such as Gaussian, gamma, and exponential distributions. Discrete models such as Bernoulli and multinomial distributions can be used.

### E. Other Modules

The data analysis application can further comprise a module configured to annotate the putative variant. A putative variant can be annotated with respect to impact of the variant in a coding region, a predicted phenotype caused by the variant, cross reference to other databases of one or more germline mutations or one or more somatic mutations, one or more mutation-drug interactions, one or more observed mutations in clinical trials, one or more diseases, one or more syndromes, or one or more side effects.

The data analysis application can further comprise a module configured to assess clinical implications regarding a variant, a chromosomal locus, or a chromosomal region. In some examples, clinical implications can be assessed on a sample or an individual. For example, an assessment can be used to recommend a therapy method, a treatment method, a treatment progress, a predicted outcome, a predicted efficacy, or a risk.

### III. Methods

The methods provided herein can include use of computer systems or computer readable media. An example of a method is provided in FIG. 1.

Methods provided herein can make use of one or more samples from an individual. One or more sequencing libraries can be prepared from the one or more samples. Sequencing libraries can be used in a sequencing process or in a data analysis. Sequencing libraries can be prepared by any of the methods disclosed herein. Two or more libraries can be prepared at the same time or at different times. For example, a sequencing library can be prepared from nucleic acids extracted from a tumor biopsy. A sequencing library can be prepared from nucleic acids extracted from a cell-free DNA sample from the subject, e.g., after a sequencing library from a tumor biopsy is prepared.

Sequencing libraries can be sequenced to provide sequencing reads. Sequencing reads can be aligned to a reference genome, e.g., a reference genome described. The reference genome can be a human reference genome, such as a public human genome (e.g., hg18, hg19, or hg37).

The read alignments from sequencing libraries from one or more samples from the subject can be described by joint probabilities, and thus can be analyzed jointly. In some cases, read alignments from all available sequencing libraries from samples (e.g., samples from tumor and normal tissues; samples from solid tissues and bodily fluids; pretreatment and post treatment samples) from a subject are analyzed jointly. In some cases, alignments from sequencing libraries from previously analyzed subjects are also included in the analysis.

In some embodiments, a probability that a putative variant at a locus from a sequence library of nucleic acids derived from a tumor sample from the subject is a somatic mutation can be determined. The probability that a putative variant is derived from tumor or germline nucleic acid (e.g., DNA) can be determined at least in part by analyzing one or more features, described below.

A mutation can refer to a change of the nucleotide sequence of a genome as compared to a reference. Mutations can involve large sections of DNA (e.g., copy number variation). Mutations can involve whole chromosomes (e.g., aneuploidy). Mutations can involve small sections of DNA. Examples of mutations involving small sections of DNA include, e.g., point mutations or single nucleotide polymorphisms, multiple nucleotide polymorphisms, insertions (e.g., insertion of one or more nucleotides at a locus), multiple nucleotide changes, deletions (e.g., deletion of one or more nucleotides at a locus), and inversions (e.g., reversal of a sequence of one or more nucleotides). The term “copy number variation” or “CNV” can refer to differences in the copy number of genetic information. CNV can refer to differences in the per genome copy number of a genomic region. For example, in a diploid organism the expected copy number for autosomal genomic regions is 2 copies per genome. Such genomic regions can be present at 2 copies per cell. For a recent review see Zhang et al. Annu. Rev. Genomics Hum. Genet. 2009. 10:451-81. CNV can be a source of genetic diversity in humans and can be associated with complex disorders and disease, for example, by altering gene dosage, gene disruption, or gene fusion. They can also represent benign polymorphic variants. CNVs can be large, for example, larger than 1 Mb, or smaller, for example between 100 bases and 1 Mb. More than 38,000 CNVs greater than 100 bases (and less than 3 Mb) have been reported in humans. Along with SNPs these CNVs can account for a significant amount of phenotypic variation between individuals. In addition to having deleterious impacts, e.g. causing disease, they can also result in advantageous variation. The term “structural variation” can refer to variation in the structure of chromosome. Structural variations can be deletions, duplications, copy-number variants, insertions, inversions, and translocations. In some cases, two regions that are far apart are brought into proximity. A hybrid gene formed from two previously separate genes, which can be joined by, for example, by translocation, deletion, or inversion events, can be referred to as a “gene fusion” or “fusion gene.”

### A. Additional Samples from a Same Subject

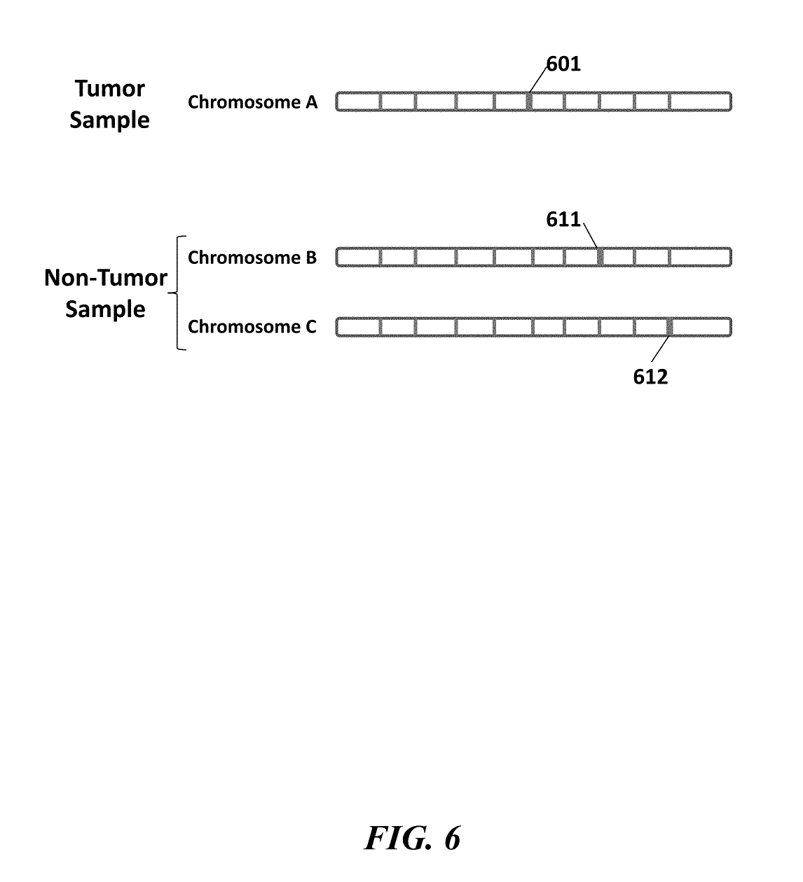

The probability that a putative variant is derived from tumor or germline nucleic acid, e.g., DNA, can be determined in part by detecting a germline variant and/or somatic mutation at a chromosomal locus in a sample other than the tumor sample from the subject. For example, referring to FIG. 6, the locus 601 at chromosome A is known to be associated with a cancer. On the other hand, variants at locus 611 of chromosome B and locus 612 of chromosome C in a non-tumor sample (e.g., blood) are signatures of tumor formation. Thus, evaluating variants at loci 611 and 612 can be used to compute a probability that the subject has a tumor mutation at locus 601.

For example, in some cases, if a patient's germline cells comprise a BRCA1 variant, then the BRCA1 variant is not derived from a tumor somatic mutation. Other scenarios can be considered in a probabilistic model. For example, one scenario is that BRCA1 mutation occurred independently in germline cells and tumor cells. Another scenario is that BRCA1 mutation is present in one cell type but absent in another cell type.

### B. Frequency of Variant Presence Around a Locus

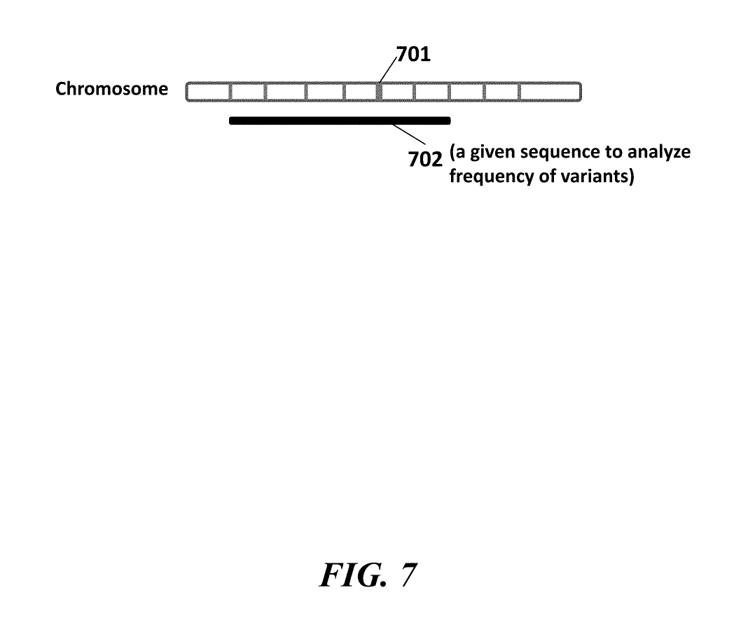

The probability that a putative variant is derived from tumor or germline nucleic acid, e.g., DNA, can be determined in part by evaluating the frequency of a presence of a variant in a set of sequence reads aligned across the locus that comprises the variant. For example, referring to FIG. 7, a tumor mutation is known to occur at the locus 701. Frequently, variants also occur near locus 701. When given a sample's sequence 702 covering the locus 701, evaluating if the sample has a tumor mutation at 701 can be assessed by analyzing a frequency of one or more variants in the neighborhood of the locus 701. When the frequency is high, the probability of the mutation happening at locus 701 is high.

For example, if a biopsy is sequenced and the reads covering a known tumor mutation are missing, the probability that the mutation variant exists can be inferred by analyzing the sequence reads in the neighborhood of the tumor locus. When the neighborhood contains more variants, the probability that sample comprises the tumor mutation is high.

### C. Error Rate in Sequencing Instrument

The probability that a putative variant is derived from tumor or germline nucleic acid, e.g., DNA, can be determined by analyzing an error rate of a sequencing instrument used to generate sequence reads used for read alignment. An error and/or noise can occur during the process of sample preparation and sequencing. Thus, an error rate reported by a sequence instrument can be used to evaluate if a putative variant is due to an error.

The error rate of the sequencing instrument can be determined at least in part by the sequence quality scores provided with the sequencing reads (e.g., FastQ score, which is a text-based format for storing both a biological sequence and its corresponding quality scores). In some cases, the error rate is adjusted by calibration information. Such calibration information can be determined by, for example, directly detecting variants that are most likely due to sequencing errors or PCR variants by quantifying the amount of low-frequency putative variants.

### D. Ploidy

The probability that a putative variant is derived from tumor or germline nucleic acid, e.g., DNA, can be determined by analyzing a ploidy of a chromosomal segment in the tumor sample. When a chromosome or a chromosomal segment has an unexpected duplicate in a sample, the probability of a tumor mutation increases.

In some cases, the ploidy estimation comprises diploid, monoploid, homoploid, zygoidy, or ployploid. In some cases, gene, regional or chromosomal duplication in a tumor can occur and the ploidy can be inferred, either by comparison to control samples or other sequences of the same sample. Further, other information hidden in a sample can be used; for example, medical history of a sample, another putative variant associated with a putative variant with high likelihood.

### E. Cancer Evolution

The probability that a putative variant is derived from tumor or germline nucleic acids, e.g., DNA and RNA, can be determined by analyzing the process of cancer clonal evolution. In various applications, a first state can be described by a first probabilistic model, and a second state can be described by a second probabilistic model. A transition from a first state to a second state can be described by a stochastic process that transforms the first probabilistic model to the second probabilistic model. Once a stochastic process characterizes a cancer evolution process, observed data in the first state can be used to infer or predict a possible condition in the second state.

Examples of cancer clonal evolution that can be considered in analysis include, but not limited to, a time of evolution from a cancer stage to another cancer stage, a size of a tumor tissue as it evolves over time, a metastasis process from a primary organ to another remote organ, a cancer growing process with accompanying symptoms, or a combination thereof.

### F. Information from Other Subjects

The probability that a putative variant is derived from tumor or germline nucleic acid, e.g., DNA, can be determined by analyzing a base call at the same locus in a sample from a different subject. Subjects from a same family or from a same race or from a same population can share similar genetic characteristics. For example, knowledge of presence or absence of a polymorphism at the locus in a reference population can be modeled as prior probability. Therefore, genetic information from other subjects can provide additional information to compute the probability.

For example, certain loci can comprise more variation within the general population, while some loci can exhibit a high level of specificity. The prior probability that a locus with a high level of variation within the general population comprises a variant is higher than the prior probability that a locus that exhibits a high level of purifying selection comprises a variant. Frequencies of variants at particular loci can be determined by prior or concurrent observations, such as the 1000 genomes project or published studies.

### G. Recurrent Cancer Mutations

The probability that a putative variant is derived from tumor or germline nucleic acid, e.g., DNA, can be determined by analyzing knowledge of recurrent cancer mutations at the locus. A mutation previously identified in an early sample can occur again in a later sample. Thus, a recurrent cancer mutation can provide a prior probability model. Such frequencies can be determined by, for example, from additional observations from cancer patients (e.g., from COSMIC or TGCA).

### H. Cellularity Estimates

The probability that a putative variant is derived from tumor or germline nucleic acid, e.g., DNA, can be determined by analyzing a percentage of cancer cells in a sample. When a sample contains more cancer cells, the probability of a putative variation being a tumor (somatic) mutation becomes higher. Therefore, estimating cancer cell percentage can provide additional information in recognizing a putative variant.

Cellularity can be the fraction of nucleic acids in a sample derived from a tumor. Cellularity can be estimated by examination (e.g., visual examination) of a biopsy sample prior to nucleic acid extraction. The examination can be based on visual, imaging, pathological studies, or medical history. Cellularity can be determined by the level of tumor-derived variants within a nucleic acid sample. In some cases, cellularity is a value between 0 and 1 that is indicative of the probability that a nucleic acid (e.g., DNA) molecule from the germline is present in the tumor sample.

### I. Correction Factor

The probability that a putative variant is derived from tumor or germline nucleic acid, e.g., DNA, can be determined at least in part by determining the frequency of each variant at the locus in data for another subject or from empirical data from previous samples. In some cases, a correction factor can be employed such that a previously unobserved variant is not assigned a zero prior probability of occurring. The correction factor can be a Laplace correction. Methods to determine the probability can be as described, e.g., in Cleary et al., Joint Variation and De Novo Mutation Identification on Pedigrees from High-Throughput Sequencing Data, Journal of Computational Biology vol. 21, pp. 405-419 (2014), which is hereby incorporated by reference in its entirety.

### IV. Computational Methods

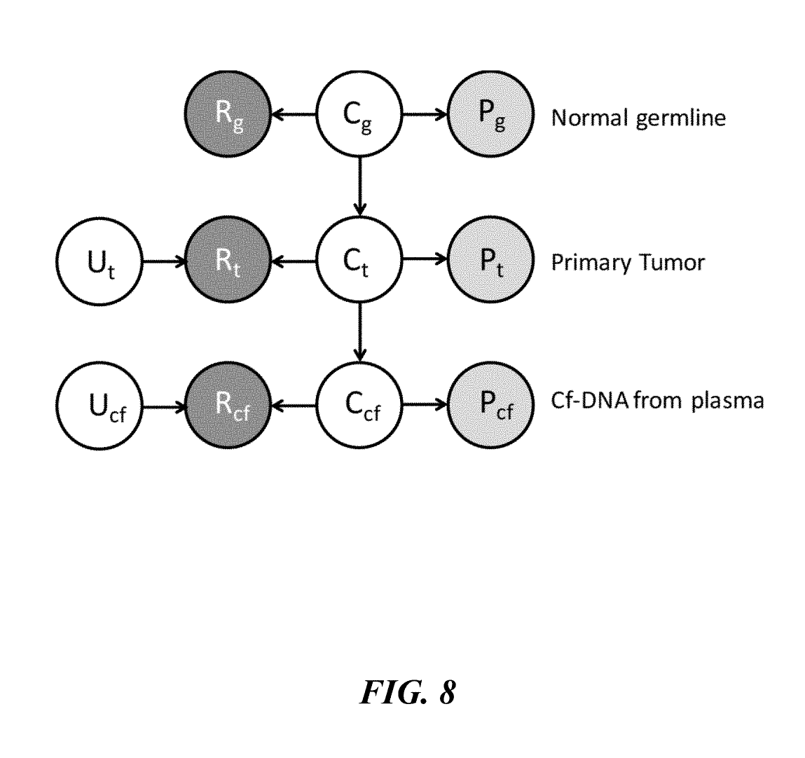

An exemplary method for determining the probability that a variant is derived from tumor or germline DNA is to utilize a Bayesian Network (see e.g., Koller & Friedman, Probabilistic Graphical Models, which is hereby incorporated by reference in its entirety). FIG. 8 illustrates an exemplary Bayesian network diagram. In the network diagram, “C” represents the variant call to be inferred, “R” represents the base calls of the set of aligned reads across the locus, “P” is the ploidy at the locus, and “U” is represents the cellularity of the sample. In order to infer the probability that a variant is derived from a tumor or germline DNA molecule in each sample, suitable values can be supplied for the following Conditional Probability Distributions (CPDs): (a) P(R|C), the probability of a set of reads given a particular variant call, (b) P(Cₜ|C_{g}), the probability of a primary tumor call given those of the germline at that locus, and (c) P(C_{cf}|Cₑ), the probability of a tumor call in the cf-DNA given the call in the primary tumor sample.

Cellularity can be accounted for by the variable “U” in the Bayesian network, which can represent the cellularity (e.g., the probability that a sequencing read is from cancer cells, a value between 0 and 1). While this value can be provided prior to analysis, in some cases it can be inferred from the data by providing prior estimate. When considering cellularity, two new CDPs can be estimated: P(Uₜ|Rₜ) and P(U_{ct}|R_{ct}), the probability of a cellularity fraction in the tumor given the reads in the tumor, and the probability of a cellularity fraction in the plasma given the reads in the plasma cell-free fraction of plasma.

Population calling methods can be combined with these methods to improve the detection of germline mutations in the healthy tissue by jointly calling with a bank of data from other samples, e.g., using methods described in Cleary et al., Journal of Computational Biology, vol. 21, pp. 405-419 2014, but while jointly calling the germline with the cancer tissue.

The CPD P(R|C) can be as described in Cleary et al., Journal of Computational Biology, vol. 21, pp. 405-419 (2014). The CPD of (b) and (c) above can be determined based on empirical values for somatic mutation rates that can be adjusted per tumor type and predominant mutational signatures. In the case of P(Cₜ|C_{g}), and by assuming a simple lineage relationship between primary tumor and the tumor DNA detected in the cell-free bodily fluid, the CDP can be determined using, e.g., similar calculations to those described in, Cleary et al., Journal of Computational Biology, vol. 21, pp. 405-419 (2014) to detect de novo mutations in offspring assuming simple inheritance of variants rather than Mendelian segregation.

In one example, only primary tumor tissue or cell-free DNA is available for analysis. In such a case, prior information can be used to estimate the CDPs, such as P(Cₜ|Cₜₚ), where Cₜₚ is the prior probability of observing a specific somatic mutation allele at that locus based on prior observations in cancer patients, and P(Gₜ|Gₚ), where Gₜ is the genotype of a germline variant present in the tumor given Gₚ, the probability of observing a particular genotype at this locus derived from population scale surveys of variation (such as the 1000 genomes project). These probabilities can then be provided as scores for each variant analyzed in the output, recalibrated if needed based on empirical validation using machine learning methods, and later used to determine appropriate false-positive and/or false-negative rate for a given application, such as downstream annotation or clinical reporting.

### V. Computing Systems

Methods, computer systems, or computer readable media provided herein can comprise or make use of a processor. A processor can include one or more hardware central processing units (CPUs) processors. A processor can be a desktop computer processor, server processor, and mobile processor. A processor can include a microprocessor.

A memory module can be used in or with the methods computer systems, or computer readable media provided herein. A memory module can be one or more physical apparatuses used to store data or programs on a temporary or permanent basis. The memory module can be volatile memory and can require power to maintain stored information. In some cases, the memory module is non-volatile memory and retains stored information when the computing system is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM).

The methods, computer systems, or computer readable media provided herein can comprise or make use of an operating system. An operating system can be, for example, software, including programs and data, that can manage a device's hardware and provide services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

Machine readable instructions can include a sequence of instructions, executable in the digital processing device's CPU, written to perform a specified task. In light of the disclosure provided herein, those of skill in the art will recognize that a computer program can be written in various versions of various languages. In some embodiments, machine readable instructions comprise one sequence of instructions. In some embodiments, machine readable instructions comprise a plurality of sequences of instructions. In some embodiments, machine readable instructions are provided from one location. In other embodiments, machine readable instructions are provided from a plurality of locations. In various embodiments, machine readable instructions include one or more software modules. In various embodiments, machine readable instructions include, in part or in whole, one or more web applications, one or more mobile applications, one or more standalone applications, one or more web browser plug-ins, extensions, add-ins, or add-ons, or combinations thereof.

Computer readable storage media can include a memory module. A computer readable storage medium can be a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

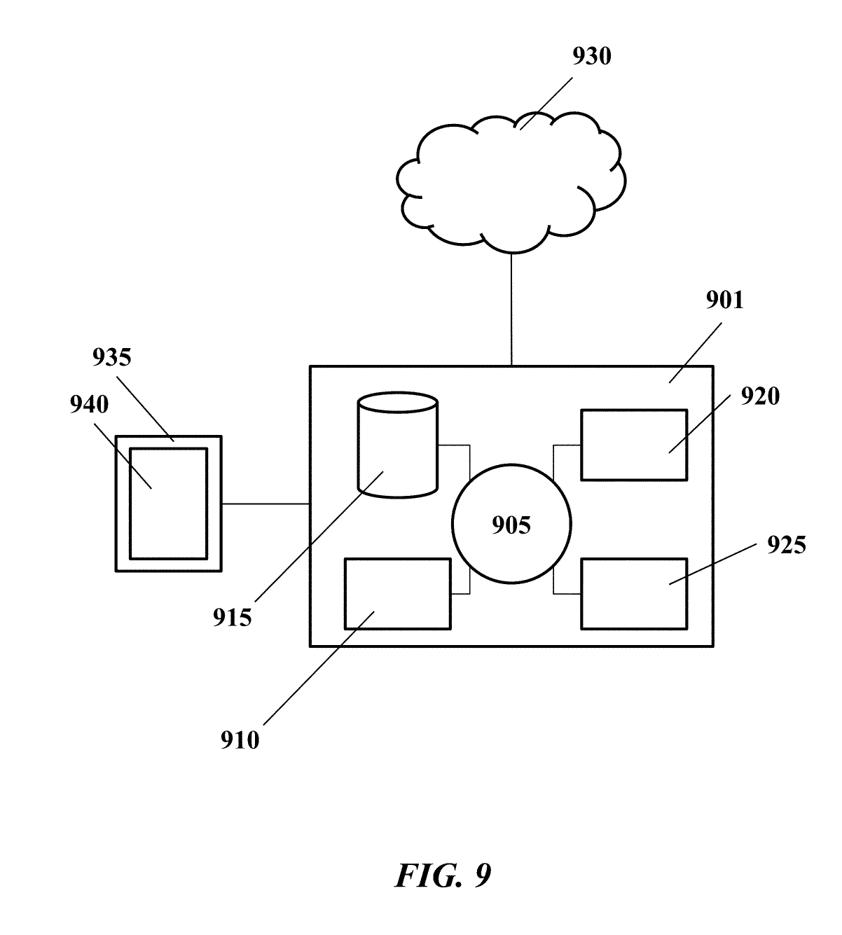

The present disclosure provides computer control systems that are programmed to implement methods of the disclosure. FIG. 9 shows a computer system 901 that is programmed or otherwise configured to perform sequence analysis disclosed. The computer system 901 can be an electronic device of a user or a computer system that is remotely located with respect to the electronic device. The electronic device can be a mobile electronic device.

The computer system 901 can include a central processing unit (CPU, also “processor” and “computer processor” herein) 905, which can be a single core or multi core processor, or a plurality of processors for parallel processing. The computer system 901 can also include memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which can enable devices coupled to the computer system 901 to behave as a client or a server.

The CPU 905 can execute a sequence of machine-readable instructions, which can be embodied in a program or software. The instructions can be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 101 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology can be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which can provide non-transitory storage at any time for the software programming. All or portions of the software can at times be communicated through the Internet or various other telecommunication networks. Such communications, for example, can enable loading of the software from one computer or processor into another, for example, from a management server or host computer into the computer platform of an application server. Thus, another type of media that can bear the software elements includes optical, electrical and electromagnetic waves, such as used across physical interfaces between local devices, through wired and optical landline networks and over various air-links. The physical elements that carry such waves, such as wired or wireless links, optical links or the like, also can be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, can take many forms, including but not limited to, a tangible storage medium, a carrier wave medium or physical transmission medium. Non-volatile storage media include, for example, optical or magnetic disks, such as any of the storage devices in any computer(s) or the like, such as can be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media can be involved in carrying one or more sequences of one or more instructions to a processor for execution.

The computer system 901 can include or be in communication with an electronic display 935 that comprises a user interface (UI) 940 for providing, for example, analysis results. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, include Bayesian networks or statistical analysis.

### VI. Sequencing and High-Throughput Sequencing Instruments

A high-throughput sequencing instrument used in or with the methods, computer systems, kits, or computer readable media provided herein can be a next-generation sequencing (NGS) platform (a platform for massively parallel sequencing). Sequencing can refer to a method by which the identity of at least 10 consecutive nucleotides (e.g., the identity of at least 20, at least 50, at least 100, at least 200, or at least 500 or more consecutive nucleotides) of a polynucleotide are obtained.

NGS technology can involve sequencing of clonally amplified DNA templates or single DNA molecules in a massively parallel fashion (e.g., as described in Volkerding et al. Clin Chem 55:641-658 [2009]; Metzker M Nature Rev 11:31-46 [2010]). In addition to high-throughput sequence information, NGS can provide digital quantitative information, in that each sequence read is a countable “sequence tag” representing an individual clonal DNA template or a single DNA molecule. Sequencing can be targeted sequencing, exome sequencing, or whole-genome sequencing. In some cases, cell-free DNA from a liquid biopsy is sequenced. In some cases, nucleic acid from circulating tumor cells (CTCs) from a liquid biopsy are sequenced. In some cases, nucleic acid from single normal and/or cancer cells are sequenced.

While the automated Sanger method is considered as a “first generation” technology, Sanger sequencing, including the automated Sanger sequencing, can also be employed by the methods provided herein. Additional sequencing methods that comprise the use of developing nucleic acid imaging technologies, e.g., atomic force microscopy (AFM) or transmission electron microscopy (TEM), can be used in the methods described herein.

The high-throughput sequencing platform (next-generation sequencing platform) used in or with the methods, computer systems, or computer readable media provided herein can be a commercially available platform. Commercially available platforms include, e.g., platforms for sequencing-by-synthesis, ion semiconductor sequencing, pyrosequencing, reversible dye terminator sequencing, sequencing by ligation, single-molecule sequencing, sequencing by hybridization, and nanopore sequencing. Platforms for sequencing by synthesis are available from, e.g., Illumina, 454 Life Sciences, Helicos Biosciences, and Qiagen. Illumina platforms can include, e.g., Illumina's Solexa platform, Illumina's Genome Analyzer, and are described, e.g., in Gudmundsson et al (Nat. Genet. 2009 41:1122-6), Out et al (Hum. Mutat. 2009 30:1703-12) and Turner (Nat. Methods 2009 6:315-6), U.S. Patent Application Pub nos. US20080160580 and US20080286795, U.S. Pat. Nos. 6,306,597, 7,115,400, and 7,232,656. 454 Life Science platforms include, e.g., the GS Flex and GS Junior, and are described in U.S. Pat. No. 7,323,305. Platforms from Helicos Biosciences include the True Single Molecule Sequencing platform. Platforms for ion semiconductor sequencing include, e.g., the Ion Torrent Personal Genome Machine (PGM) and are described, e.g., in U.S. Pat. No. 7,948,015. Platforms for pryosequencing include the GS Flex 454 system and are described, e.g., in U.S. Pat. Nos. 7,211,390; 7,244,559; 7,264,929. Platforms and methods for sequencing by ligation include, e.g., the SOLiD sequencing platform and are described, e.g., in U.S. Pat. No. 5,750,341. Platforms for single-molecule sequencing include, e.g., the SMRT system from Pacific Bioscience.

A high-throughput sequencing instrument used in or with the methods, computer systems, or computer readable media provided herein can be an Ion Torrent sequencing platform, which can pair semiconductor technology with a sequencing chemistry to directly translate chemically encoded information (A, C, G, T) into digital information (0, 1) on a semiconductor chip. Without wishing to be bound by theory, when a nucleotide is incorporated into a strand of DNA by a polymerase, a hydrogen ion is released as a byproduct. The Ion Torrent platform can detect the release of the hydrogen atom as a change in pH. A detected change in pH can be used to indicate nucleotide incorporation. An Ion Torrent platform can comprise a high-density array of micro-machined wells to perform this biochemical process in a massively parallel way. Each well can hold a different library member, which can be clonally amplified. Beneath the wells can be an ion-sensitive layer and beneath that an ion sensor. The platform can sequentially flood the array with one nucleotide after another. When a nucleotide, for example a C, is added to a DNA template and is then incorporated into a strand of DNA, a hydrogen ion can be released. The charge from that ion can change the pH of the solution, which can be identified by Ion Torrent's ion sensor. If the nucleotide is not incorporated, no voltage change will be recorded and no base will be called. If there are two identical bases on the DNA strand, the voltage can be double, and the chip can record two identical bases called. Direct identification allows recordation of nucleotide incorporation in seconds. Library preparation for the Ion Torrent platform can involve adding (e.g., by ligation) of two distinct adaptors at both ends of a DNA fragment.

A high-throughput sequencing instrument used in or with the methods, computer systems, or computer readable media provided herein Illumina sequencing platform, which can employs cluster amplification of library members on a flow cell and a sequencing-by-synthesis approach. Cluster-amplified library members can be subjected to repeated cycles of polymerase-directed single base extension. Single-base extension can involve incorporation of reversible-terminator dNTPs, each dNTP labeled with a different removable fluorophore. The term “label” and “detectable moiety” can be used interchangeably herein to refer to any atom or molecule which can be used to provide a detectable signal, and which can be attached to a nucleic acid or protein. Labels can provide signals detectable by fluorescence, radioactivity, colorimetry, gravimetry, X-ray diffraction or absorption, magnetism, enzymatic activity, and the like.

The reversible-terminator dNTPs can be 3′ modified to prevent further extension by the polymerase. After incorporation, the incorporated nucleotide can be identified by fluorescence imaging. Following fluorescence imaging, the fluorophore can be removed and the 3′ modification can be removed resulting in a 3′ hydroxyl group, thereby allowing another cycle of single base extension. Library preparation for the Illumina platform can involve adding (e.g., by ligation) two distinct adaptors at both ends of a DNA fragment.

A high-throughput sequencing instrument used in or with the methods, computer systems, or computer readable media provided herein can be the Helicos True Single Molecule Sequencing (tSMS) platform, which can employ sequencing-by-synthesis technology. In the tSMS technique, a polyA adaptor can be ligated to the 3′ end of DNA fragments. The adapted fragments can be hybridized to poly-T oligonucleotides immobilized on the tSMS flow cell. The library members can be immobilized onto the flow cell at a density of about 100 million templates/cm². The flow cell can be then loaded into an instrument, e.g., HeliScope™ sequencer, and a laser can illuminate the surface of the flow cell, revealing the position of each template. A CCD camera can map the position of the templates on the flow cell surface. The library members can be subjected to repeated cycles of polymerase-directed single base extension. The sequencing reaction begins by introducing a DNA polymerase and a fluorescently labeled nucleotide. The polymerase can incorporate the labeled nucleotides to the primer in a template directed manner. The polymerase and unincorporated nucleotides can be removed. The templates that have directed incorporation of the fluorescently labeled nucleotide can be discerned by imaging the flow cell surface. After imaging, a cleavage step can remove the fluorescent label, and the process can be repeated with other fluorescently labeled nucleotides until a desired read length is achieved. Sequence information can be collected with each nucleotide addition step.

A high-throughput sequencing instrument used in or with the methods, computer systems, or computer readable media provided herein can be a 454 sequencing platform (Roche) (e.g., as described in Margulies, M. et al. Nature 437:376-380 [2005]). 454 sequencing can involve two steps. In a first step, DNA can be sheared into fragments. The fragments can be blunt-ended. Oligonucleotide adaptors can be ligated to the ends of the fragments. The adaptors can serve as primers for amplification and sequencing of the fragments. At least one adaptor can comprise a capture reagent, e.g., a biotin. The fragments can be attached to DNA capture beads, e.g., streptavidin-coated beads. The fragments attached to the beads can be PCR amplified within droplets of an oil-water emulsion, resulting in multiple copies of clonally amplified DNA fragments on each bead. In a second step, the beads can be captured in wells, which can be pico-liter sized. Pyrosequencing can be performed on each DNA fragment in parallel. Pyrosequencing can detect release of pyrophosphate (PPi) upon nucleotide incorporation. PPi can be converted to ATP by ATP sulfurylase in the presence of adenosine 5′ phosphosulfate. Luciferase can use ATP to convert luciferin to oxyluciferin, thereby generating a light signal that is detected. A detected light signal can be used to identify the incorporated nucleotide.

A high-throughput sequencing instrument used in or with the methods, computer systems, or computer readable media provided herein can utilize SOLiD™ technology (Applied Biosystems). The SOLiD platform can utilize a sequencing-by-ligation approach. Library preparation for use with a SOLiD platform can comprise ligation of adaptors to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations can be prepared in microreactors containing beads, primers, template, and PCR components. Following PCR, the templates can be denatured. Beads can be enriched for beads with extended templates. Templates on the selected beads can be subjected to a 3′ modification that permits bonding to a glass slide. The sequence can be determined by sequential hybridization and ligation of partially random oligonucleotides with a central determined base (or pair of bases) that is identified by a specific fluorophore. After a color is recorded, the ligated oligonucleotide can be removed and the process can then be repeated.

A high-throughput sequencing instrument used in or with the methods, computer systems, or computer readable media provided herein can be a single molecule, real-time (SMRT™) sequencing platform (Pacific Biosciences). In SMRT sequencing, the continuous incorporation of dye-labeled nucleotides can be imaged during DNA synthesis. Single DNA polymerase molecules can be attached to the bottom surface of individual zero-mode wavelength identifiers (ZMW identifiers) that obtain sequence information while phospholinked nucleotides are being incorporated into the growing primer strand. A ZMW can refer to a confinement structure which can enable observation of incorporation of a single nucleotide by DNA polymerase against a background of fluorescent nucleotides that rapidly diffuse in an out of the ZMW on a microsecond scale. By contrast, incorporation of a nucleotide can occur on a milliseconds timescale. During this time, the fluorescent label can be excited to produce a fluorescent signal, which can be detected. Detection of the fluorescent signal can be used to generate sequence information. The fluorophore can then be removed, and the process repeated. Library preparation for the SMRT platform can involve ligation of hairpin adaptors to the ends of DNA fragments.

A high-throughput sequencing instrument used in or with the methods, computer systems, or computer readable media provided herein can use nanopore sequencing (e.g. as described in Soni G V and Meller A. Clin Chem 53: 1996-2001 [2007]). Nanopore sequencing DNA analysis techniques include techniques from Oxford Nanopore Technologies (Oxford, United Kingdom). Nanopore sequencing can be a single-molecule sequencing technology whereby a single molecule of DNA is sequenced directly as it passes through a nanopore. A nanopore can be a small hole, of the order of 1 nanometer in diameter. Immersion of a nanopore in a conducting fluid and application of a potential (voltage) across can result in a slight electrical current due to conduction of ions through the nanopore. The amount of current which flows can be sensitive to the size and shape of the nanopore and to occlusion by, e.g., a DNA molecule. As a DNA molecule passes through a nanopore, each nucleotide on the DNA molecule can obstruct the nanopore to a different degree, changing the magnitude of the current through the nanopore in different degrees. Thus, this change in the current as the DNA molecule passes through the nanopore can represent a reading of the DNA sequence.

A high-throughput sequencing instrument used in or with the methods, computer systems, or computer readable media provided herein can utilize a chemical-sensitive field effect transistor (chemFET) array (e.g., as described in U.S. Patent Application Publication No. 20090026082). In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be discerned by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

A high-throughput sequencing instrument used in or with the methods, computer systems, or computer readable media provided herein can utilize transmission electron microscopy (TEM). The method, termed Individual Molecule Placement Rapid Nano Transfer (IMPRNT), can comprise single atom resolution transmission electron microscope imaging of high-molecular weight (150 kb or greater) DNA selectively labeled with heavy atom markers and arranging these molecules on ultra-thin films in ultra-dense (3 nm strand-to-strand) parallel arrays with consistent base-to-base spacing. The electron microscope can be used to image the molecules on the films to determine the position of the heavy atom markers and to extract base sequence information from the DNA. The method can be further described in PCT patent publication WO 2009/046445. The method can allow for sequencing complete human genomes in less than ten minutes.

A high-throughput sequencing instrument used in or with the methods, computer systems, or computer readable media provided herein can utilize sequencing by hybridization (SBH). SBH can comprises contacting a plurality of polynucleotide sequences with a plurality of polynucleotide probes, wherein each of the plurality of polynucleotide probes can be optionally tethered to a substrate. The substrate can be flat surface comprising an array of known nucleotide sequences. The pattern of hybridization to the array can be used to determine the polynucleotide sequences present in the sample. In other embodiments, each probe is tethered to a bead, e.g., a magnetic bead or the like. Hybridization to the beads can be identified and used to identify the plurality of polynucleotide sequences within the sample.

The length of the sequence read can vary depending on the particular sequencing technology utilized. High-throughput sequencing instrument (NGS platforms) can provide sequence reads that vary in size from tens to hundreds, or thousands of base pairs. In some embodiments of the method described herein, the sequence reads are about, or at least, 10 bases long, 15 bases long, 20 bases long, 25 bases long, 30 bases long, 35 bases long, 40 bases long, 45 bases long, 50 bases long, 55 bases long, 60 bases long, 65 bases long, 70 bases long, 75 bases long, 80 bases long, 85 bases long, 90 bases long, 95 bases long, 100 bases long, 110 bases long, 120 bases long, 130, 140 bases long, 150 bases long, 200 bases long, 250 bases long, 300 bases long, 350 bases long, 400 bases long, 450 bases long, 500 bases long, 600 bases long, 700 bases long, 800 bases long, 900 bases long, 1000 bases long, or more than 1000 bases long.

The sequencing platforms described herein can comprise a solid support immobilized thereon surface-bound oligonucleotides which allow for the capture and immobilization of sequencing library members to the solid support. Surface bound oligonucleotides generally comprise sequences complementary to the adaptor sequences of the sequencing library.

A high-throughput sequencing platform can be used to sequence DNA to different depths. Depth in sequencing (e.g., DNA sequencing) can refer to the number of times a nucleotide is read during the sequencing process. Sequence coverage can indicate the average number of reads representing a given nucleotide in a reconstructed sequence. Physical coverage can be the average number of times a base is read or spanned by mate paired reads. Depth can be calculated from the length of the original genome (G), the number of reads (N), and the average read length (L) as: N×L/G. In some cases, deep sequencing (>7×) is performed. In some cases, ultra-deep sequencing is performed (>100×). Sequencing depth in the methods disclosed herein can be at least 1×, 2×, 5×, 7×, 10×, 20×, 50×, 75×, 100×, 250×, 500×, 1000×, 5000×, or 10,000×.

### VII. Subjects, Samples, and Nucleic Acids

### A. Subjects

Samples analyzed in the methods, computer systems, and computer readable media provided herein can come from one or more subjects or individuals. A subject can be a biological entity containing expressed genetic materials. The biological entity can be a plant, animal, or microorganism, including, e.g., bacteria, viruses, fungi, and protozoa. The subject can be tissues, cells and their progeny of a biological entity obtained in vivo or cultured in vitro. The subject can be a mammal. The mammal can be a human. The human can be a male or female. The human can be from 1 day to about 1 year old, about 1 year old to about 3 years old, about 3 years old to about 12 years old, about 13 years old to about 19 years old, about 20 years old to about 40 years old, about 40 years old to about 65 years old, or over 65 years old. The human can be diagnosed or suspected of being at high risk for a disease. The disease can be cancer. The human may not be diagnosed or suspected of being at high risk for a disease.

### B. Samples

The one or more samples used in or with the methods, computer systems, and computer readable media provided herein can be any substance containing or presumed to contain nucleic acid. The sample can be a biological sample obtained from a subject. In some embodiments, the biological sample is a liquid sample. The liquid sample can be whole blood, plasma, serum, ascites, cerebrospinal fluid, sweat, urine, tears, saliva, buccal sample, cavity rinse, or organ rinse. The liquid sample can be an essentially cell-free liquid sample, or comprise cell-free nucleic acid (e.g., plasma, serum, sweat, plasma, urine, sweat, tears, saliva, sputum, cerebrospinal fluid). In other embodiments, the biological sample is a solid biological sample, e.g., feces or tissue biopsy. A sample can also comprise in vitro cell culture constituents (including but not limited to conditioned medium resulting from the growth of cells in cell culture medium, recombinant cells and cell components). The sample can comprise a single cell, e.g., a cancer cell, a circulating tumor cell, a cancer stem cell, and the like. A sample can comprise a plurality of cells. In some cases, a sample comprises about, or at least, 1%, 5%, 10%, 15%, 20%, 25%, 30%, 35%, 40%, 45%, 50%, 55%, 60%, 65%, 70%, 75%, 80%, 85%, 90%, 95%, 99%, or 100% tumor cells. The subject can be suspected or known to harbor a solid tumor, or can be a subject who previously harbored a solid tumor.

In some cases, both a tumor sample and normal cells from the subject are obtained from a subject.

In some embodiments, nucleic acids comprising germline sequence are extracted from a biological sample from a subject. In some embodiments, the biological sample is a solid tissue. The biological sample can be tissue, such as healthy tissue from the subject. The biological sample can be a liquid sample, such as, for example, blood, buffy coat from blood (which can include lymphocytes), saliva, or plasma.

In some embodiments, nucleic acids comprising somatic variants are extracted from a biological sample from a subject. In some embodiments, the biological sample is solid tissue. The solid tissue can be, for example, a primary tumor, a metastasis tumor, a polyp, or an adenoma. In some embodiments, the biological sample is a liquid sample, such as, for example, urine, saliva, cerebrospinal fluid, plasma, or serum. In some cases, the liquid is a cell-free liquid. In some cases, cells, including circulating tumor cells, are enriched for or isolated from the liquid. In some cases, the sample comprises cell-free nucleic acid, e.g., DNA.

In some cases, a sample of a tumor is taken at first time point and sequenced, and another sample of the tumor is taken at a subsequent time point and the tumor is resequenced.

### C. Cancer

The computing systems, software media, methods and kits provided herein can make use of a tumor sample. A tumor composition (primary tumor, metastatic tumor) can include one or more DNA molecules associated with a cancer.

The computing systems, software media, methods and kits provided herein can can include estimating a percentage of tumor cells/nucleic acid in a sample.

The computing systems, software media, methods and kits provided herein can include samples collected at the same or different times (at a same time; the one or more samples comprise at least two samples, and the at least two samples are collected at different times).

The computing systems, software media, methods and kits provided herein can include use of different types of cells (e.g., lymphocytes, blood cells, tumor cells).

The computing systems, software media, methods and kits provided herein improve the monitoring and treatment of a subject suffering from a disease. The disease can be a cancer, e.g., a tumor, a leukemia such as acute leukemia, acute t-cell leukemia, acute lymphocytic leukemia, acute myelocytic leukemia, myeloblastic leukemia, promyelocytic leukemia, myelomonocytic leukemia, monocytic leukemia, erythroleukemia, chronic leukemia, chronic myelocytic (granulocytic) leukemia, or chronic lymphocytic leukemia, polycythemia vera, lymphomas such as Hodgkin's lymphoma, follicular lymphoma or non-Hodgkin's lymphoma, multiple myeloma, Waldenström's macroglobulinemia, heavy chain disease, solid tumors, sarcomas, carcinomas such as, e.g., fibrosarcoma, myxosarcoma, liposarcoma, chondrosarcoma, osteogenic sarcoma, lymphangiosarcoma, mesothelioma, Ewing's tumor, leiomyosarcoma, rhabdomyosarcoma, colon carcinoma, colorectal cancer, pancreatic cancer, breast cancer, ovarian cancer, prostate cancer, squamous cell carcinoma, basal cell carcinoma, adenocarcinoma, sweat gland carcinoma, sebaceous gland carcinoma, papillary carcinoma, papillary adenocarcinomas, cystadenocarcinoma, medullary carcinoma, bronchogenic, carcinoma, renal cell carcinoma, hepatoma, bile duct carcinoma, choriocarcinoma, seminoma, embryonal carcinoma, Wilms' tumor, cervical cancer, uterine cancer, testicular tumor, lung carcinoma, small cell lung carcinoma, bladder carcinoma, epithelial carcinoma, glioma, craniopharyngioma, ependymoma, pinealoma, hemangioblastoma, acoustic neuroma, oligodendroglioma, meningioma, melanoma, neuroblastoma, retinoblastoma, endometrial cancer, non small cell lung cancer.

### D. Nucleic Acids

The nucleic acids used in or with the methods, computer systems, and computer readable media, and kits provided herein can be RNA, DNA, e.g., genomic DNA, mitochondrial DNA, viral DNA, synthetic DNA, or cDNA reverse transcribed from RNA.

The terms “polynucleotides”, “nucleic acid”, and “oligonucleotides” can be used interchangeably. They can refer to a polymeric form of nucleotides of any length, either deoxyribonucleotides or ribonucleotides, or analogs thereof. Polynucleotides can have any three-dimensional structure, and can perform any function, known or unknown. The following are non-limiting examples of polynucleotides: coding or non-coding regions of a gene or gene fragment, loci (locus) defined from linkage analysis, exons, introns, messenger RNA (mRNA), transfer RNA, ribosomal RNA, ribozymes, cDNA, recombinant polynucleotides, branched polynucleotides, plasmids, vectors, isolated DNA of any sequence, isolated RNA of any sequence, nucleic acid probes, and primers. A polynucleotide can comprise modified nucleotides, such as methylated nucleotides and nucleotide analogs. If present, modifications to the nucleotide structure can be imparted before or after assembly of the polymer. The sequence of nucleotides can be interrupted by non-nucleotide components. A polynucleotide can be further modified after polymerization, such as by conjugation with a labeling component.

The term “target polynucleotide,”, “target region”, or “target”, as used herein, can refer to a polynucleotide of interest under study. In certain embodiments, a target polynucleotide contains one or more sequences that are of interest and under study. A target polynucleotide can comprise, for example, a genomic sequence. The target polynucleotide can comprise a target sequence whose presence, amount, and/or nucleotide sequence, or changes in these, are desired to be determined.

### VIII. Nucleic Acid Library Generation

The methods, computer systems, computer readable media, and kits provided herein can make use of nucleic acid libraries. Provided herein are methods, compositions, and kits for library nucleic acid library formation. The library formation can comprise target capture via probe hybridization and extension prior to sequencing. Paired-end reads can be used to align reads from a given probe. A process of library preparation can include generation of fragmented DNA, adapted DNA, target capture, surface loading, and sequencing, with no enrichment by amplification with primers that amplify fragments with adaptors on each end of the fragment of DNA between generation of adapted DNA and target capture.

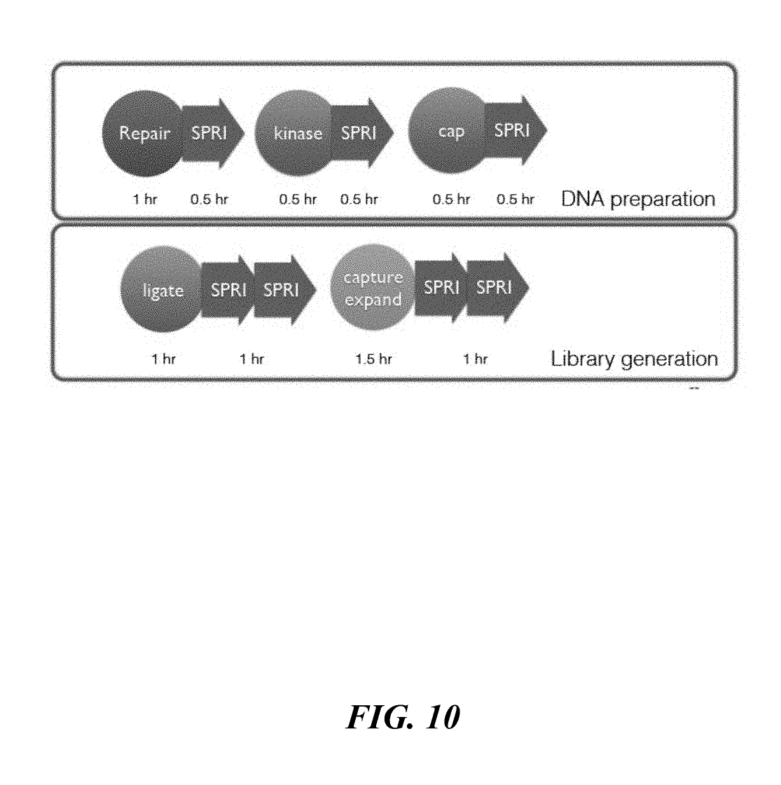

Nucleic acid samples can be used to prepare nucleic acid libraries for sequencing. Preparation of nucleic acid libraries can comprise any method known in the art or as described herein. A nucleic acid sequencing library can be formed by target enrichment, e.g., using target-specific primers. In some cases, a nucleic acid library is not based on a target-specific approach. FIG. 10 illustrates an exemplary workflow for DNA preparation and library generation. Total preparation time can be about 8 hr. Preparation can include enzymatic manipulations interspersed with incubations with Solid Phase Reverse Immoblization (SPRI) beads to purify the nucleic acid intermediate. Nucleic acid (e.g., DNA) library preparation can involve nucleic acid (e.g., DNA) preparation, which can include a) nucleic acid (e.g., DNA) repair, b) nucleic acid (e.g., DNA) phosphorylation, and/or c) nucleic acid (e.g., DNA) capping. Nucleic acid library generation can include appending (e.g., ligating) an adaptor to a nucleic acid; “capture” (e.g., annealing a target-specific primer to the nucleic acid), extension, and/or amplification. A nucleic acid library can be a single-stranded nucleic acid library or a double stranded nucleic acid library. The nucleic acid library can be a DNA library. In some embodiments, the nucleic acid library is a ssDNA library. In some embodiments, the nucleic acid library is a partial ssDNA library.

### A. Nucleic Acid Repair and Fragmentation

Nucleic acids can be repaired before forming a nucleic acid library. For example, nucleic acid (e.g., DNA) from a sample (e.g., any sample descried herein, e.g., a formalin-fixed paraffin embedded (FFPE)) sample can be used for library preparation, and nucleic acid (e.g., DNA) from a sample (e.g., an FFPE sample) can comprise mutations, e.g., oxoguanine, dUTP, cross-linked moieties, and/or abasic sites. In some cases, damaged bases are removed (e.g., excised) from the DNA sample. In some cases, no “corrective” processing steps are involved (base errors are not corrected). In some cases, nucleic acids in a sample do not comprise mutations.

In some cases, nucleic acids in a library are fragmented. The fragments used in library preparation can be have an average size of about 50 to about 500 bases/bp; about 100 to about 500 bases/bp; about 100 to about 400 bases/bp; about 100 to about 300 bases/bp; about 100 to about 200 bases/bp; about 200 to about 500 bases/bp; about 200 to about 400 bases/bp; or about 200 to about 300 bases/bp.

DNA, e.g., fragmented DNA can be treated with a base excision repair enzyme (e.g., Endo VIII, formamidopyrimidine DNA glycosylase (FPG)) to excise damaged bases that can interfere with polymerization. DNA can then be treated with a proof-reading polymerase (e.g., T4 DNA polymerase) to polish ends and replace damaged nucleotides (e.g., abasic sites). In some embodiments, DNA is not treated with a proof-reading polymerase to polish ends and replace damaged nucleotides.

### B. Nucleic Acid Processing

Fragments of nucleic acid (e.g., DNA) can be phosphorylated (e.g., with a kinase) and capped with a ddNTP. In some cases, the 5′ end of nucleic acids are phosphorylated.

### C. Adding Adaptors

Single stranded adaptors can be ligated to single stranded DNA fragments from a sample. A double digit yield of adapted DNA fragments can be achieved to allow for an improved recovery of sequence information from a sample. Adaptors can be added to a nucleic acid via, e.g., a primer or by ligation. An adaptor, e.g., a ssDNA adaptor, can be added, e.g., ligated, to a 5′ end of ssDNA, a 3′ end of a ssDNA, or both a 5′ end and a 3′ end of a ssDNA. The 5′ end of the nucleic acid fragment and/or the adaptor can be adenylated, e.g., prior to ligation reaction. The yield of the adapted DNA can be double digit.

Fragments can be modified with an adaptor sequence which can affect coupling (e.g., capture and/or immobilization) of the fragments to a sequencing platform. An adaptor sequence can comprise a defined oligonucleotide sequence that affects coupling of a library member to a sequencing platform. The adaptor can comprise a sequence that is at least 25%, 50%, 60%, 70%, 80%, 90%, or 100% complementary or identical to an oligonucleotide sequence immobilized onto a solid support (e.g., a sequencing flow cell or bead). An adaptor sequence can comprise a defined oligonucleotide sequence that is at least 50%, 60%, 70%, 80%, 90%, or 100% complementary or identical to a sequencing primer. The sequencing primer can enable nucleotide incorporation by a polymerase, wherein incorporation of the nucleotide is monitored to provide sequencing information. The sequencing primer can be about 15 to about 25 bases. An adaptor can comprise a sequence that is at least 25%, 50%, 60%, 70%, 80%, 90%, or 100% complementary or identical to an oligonucleotide sequence immobilized onto a solid support and a sequence that is at least 70% complementary or identical to a sequencing primer. Coupling can also be achieved through serially stitching adaptors together. The number of adaptors that can be stitched can be 1, 2, 3, 4 or more. The stitched adaptors can be at least 35 bases, 70 bases, 105 bases, 140 bases or more.

The adaptor can comprise a barcode sequence. The term “barcode sequence” can refer to a unique sequence of nucleotides that can encode information about an assay. A barcode sequence can encode information relating to the identity of an interrogated allele, identity of a target polynucleotide or genomic locus, identity of a sample, a subject, a molecule, or any combination thereof. A barcode sequence can be a portion of a primer, a reporter probe, or both. A barcode sequence can be at the 5′-end or 3′-end of an oligonucleotide, or can be located in any region of the oligonucleotide. A barcode sequence can or can not be part of a template sequence. Barcode sequences can vary widely in size and composition; the following references provide guidance for selecting sets of barcode sequences appropriate for particular embodiments: Brenner, U.S. Pat. No. 5,635,400; Brenner et al, Proc. Natl. Acad. Sci., 97: 1665-1670 (2000); Shoemaker et al, Nature Genetics, 14: 450-456 (1996); Morris et al, European patent publication 0799897A1; Wallace, U.S. Pat. No. 5,981,179. A barcode sequence can have a length of about 4 to 36 nucleotides, about 6 to 30 nucleotides, or about 8 to 20 nucleotides.

At least 50%, 60%, 70%, 80%, 90%, or 100% of sequencing library members in a library can comprise the same adaptor sequence. At least 50%, 60%, 70%, 80%, 90%, or 100% of the ssDNA library members can comprise an adaptor sequence at a first end but not at a second end. In some embodiments, the first end is a 5′ end. In some embodiments, the first end is at 3′ end. The adaptor sequence can be chosen by a user according to the sequencing platform used for sequencing. By way of example only, an Illumina sequencing by synthesis platform can comprise a solid support with a first and second population of surface-bound oligonucleotides immobilized thereon. Such oligonucleotides comprise a sequence for hybridizing to a first and second Illumina-specific adaptor oligonucleotide and priming an extension reaction. Accordingly, a DNA library member can comprise a first Illumina-specific adaptor that is partially or wholly complementary to a first population of surface bound oligonucleotides of an Illumina system. By way of other example only, the SOLiD system, and Ion Torrent, GS FLEX system can comprise a solid support in the form of a bead with a single population of surface bound oligonucleotides immobilized thereon. Accordingly, in some embodiments the ssDNA library member comprises an adaptor sequence that is complementary to a surface-bound oligonucleotide of a SOLiD system, Ion Torrent system, or GS Flex system.

### D. Extension

An extension product can be generated from a nucleic acid fragment. An extension product can be generated by annealing a primer to adaptor sequence on a 3′ end of nucleic acid and extending the primer. Such an extension product is not target-specific. An extension product can be generated by annealing a primer to target-specific sequence within a ss nucleic acid (e.g., ssDNA) comprising an adaptor at a 5′ end and/or 3′ end and extending the primer. Such an extension product can be a target-specific extension product. A plurality of target-specific primers (e.g., about 20 about 35 bases target-specific sequence) can be used to create a library. Target-specific primers can comprise adaptor sequence, e.g., at the 5′ end.

### E. Amplification

In some cases, no whole genome PCR is performed, which can minimize bias in representation. In some cases, no amplification is performed on an extension product, in solution. In some cases, multiple rounds of amplification are performed on an extension product, in solution, before sequencing.

### F. ssDNA Fragment/ssDNA Library Preparation (Adaptor at 3′ End)

Provided herein are methods, compositions, and kits for generating ssDNA libraries, e.g., by adding adaptors to 3′ ends of nucleic acid fragments. The single-stranded nucleic acid library can be prepared from a sample of double-stranded nucleic acid or single-stranded nucleic acid using any means known in the art or described herein.

Sample

The starting sample can be a biological sample obtained from a subject. Exemplary subjects and biological samples are described herein. The sample can be a solid biological sample, e.g., a tumor sample. The solid biological sample can be processed. Processing can comprise, e.g., fixation in a formalin solution, followed by embedding in paraffin (e.g., is a FFPE sample). Processing can comprise freezing. In some cases, the sample is neither fixed nor frozen. The unfixed, unfrozen sample can be stored in a storage solution configured for the preservation of nucleic acid. Exemplary storage solutions are described herein. In some embodiments, non-nucleic acid materials can be removed from the starting material, e.g., using enzymatic treatments (e.g., with a protease). The sample can be subjected to homogenization, sonication, French press, dounce, freeze/thaw, which can be followed by centrifugation. The centrifugation can separate nucleic acid-containing fractions from non-nucleic acid-containing fractions. In some cases, the sample is a liquid biological sample. Exemplary liquid biological samples are described herein. The liquid biological sample can be a blood sample (e.g., whole blood, plasma, or serum). A whole blood sample can be subjected to acellular components (e.g., plasma, serum) and cellular components by use of, e.g., a Ficoll reagent described in detail Fuss et al, Curr Protoc Immunol (2009) Chapter 7:Unit7.1, which is incorporated herein by reference.

Nucleic acid can be isolated from the biological sample using any means known in the art. For example, nucleic acid can be extracted from the biological sample using liquid extraction (e.g., Trizol, DNAzol) techniques. Nucleic acid can also be extracted using commercially available kits (e.g., Qiagen DNeasy kit, QIAamp kit, Qiagen Midi kit, QIAprep spin kit).

Nucleic acid can be concentrated by known methods, including, by way of example only, centrifugation. Nucleic acid can be bound to a selective membrane (e.g., silica) for the purposes of purification. Nucleic acid can also be enriched for fragments of a desired length, e.g., fragments which are less than 1000, 500, 400, 300, 200 or 100 base pairs in length. Such an enrichment based on size can be performed using, e.g., PEG-induced precipitation, an electrophoretic gel or chromatography material (Huber et al. (1993) Nucleic Acids Res. 21:1061-6), gel filtration chromatography, TSK gel (Kato et al. (1984) J. Biochem, 95:83-86), which publications are hereby incorporated by reference.

Polynucleotides extracted from a biological sample can be selectively precipitated or concentrated using any methods known in the art.

The nucleic acid sample can be enriched for target polynucleotides. Target enrichment can be by any means known in the art. For example, the nucleic acid sample can be enriched by amplifying target sequences using target-specific primers. The target amplification can occur in a digital PCR format, using any methods or systems known in the art. The nucleic acid sample can be enriched by capture of target sequences onto an array immobilized thereon target-selective oligonucleotides. The nucleic acid sample can be enriched by hybridizing to target-selective oligonucleotides free in solution or on a solid support. The oligonucleotides can comprise a capture moiety which enables capture by a capture reagent. Exemplary capture moieties and capture reagents are described herein. In some cases, the nucleic acid sample is not enriched for target polynucleotides, e.g., represents a whole genome. In some cases, whole genome amplification is performed.

The single-stranded nucleic acid library can be a single-stranded DNA library (ssDNA library) or an RNA library. A method of preparing an ssDNA library can comprise denaturing a double stranded DNA fragment into ssDNA fragments, ligating a primer sequence onto one end of the ssDNA fragment, hybridizing a primer to the primer docking sequence. The primer can comprise at least a portion of an adaptor sequence that couples to a next-generation sequencing platform. The method can further comprise extension of the hybridized primer to create a duplex, wherein the duplex comprises the original ssDNA fragment and an extended primer strand. The extended primer strand can be separated from the original ssDNA fragment. The extended primer strand can be collected, wherein the extended primer strand is a member of the ssDNA library. A method of preparing an RNA library can comprise ligating a primer docking sequence onto one end of the RNA fragment, hybridizing a primer to the primer docking sequence. The primer can comprise at least a portion of an adaptor sequence that couples to a next-generation sequencing platform. The method can further comprise extension of the hybridized primer to create a duplex, wherein the duplex comprises the original RNA fragment and an extended primer strand. The extended primer strand can be separated from the original RNA fragment. The extended primer strand can be collected, wherein the extended primer strand is a member of the RNA library.

dsDNA can be fragmented by any means known in the art or as described herein. dsDNA can be fragmented by physical means, for example, by mechanical shearing, by nebulization, or by sonication; by chemical means, such as treatment with Fe(II)-EDTA chelate; or by enzymatic means, such as a plurality of nicking enzymes, restriction enzymes, or fragmentases (NEB).

In some embodiments, cDNA is generated from RNA using random primed reverse transcription (RNaseH+) to generate randomly sized cDNA.

Fragment Size

The nucleic acid fragments (e.g., dsDNA fragments, RNA, or randomly sized cDNA) can be less than 1000 bp, less than 800 bp, less than 700 bp, less than 600 bp, less than 500 bp, less than 400 bp, less than 300 bp, less than 200 bp, or less than 100 bp. The DNA fragments can be about 40-100 bp, about 50-125 bp, about 100-200 bp, about 150-400 bp, about 300-500 bp, about 100-500, about 400-700 bp, about 500-800 bp, about 700-900 bp, about 800-1000 bp, or about 100-1000 bp.

Repair

The ends of dsDNA fragments can be polished (e.g., blunt-ended). The ends of DNA fragments can be polished by treatment with a polymerase. Polishing can involve removal of 3′ overhangs, fill-in of 5′ overhangs, or a combination thereof. The polymerase can be a proof-reading polymerase (e.g., comprising 3′ to 5′ exonuclease activity). The proofreading polymerase can be, e.g., a T4 DNA polymerase, Pol 1 Klenow fragment, or Pfu polymerase. Polishing can comprise removal of damaged nucleotides (e.g. abasic sites), using any means known in the art.

Adaptors

Ligation of an adaptor to a 3′ end of a nucleic acid fragment can comprise formation of a bond between a 3′ OH group of the fragment and a 5′ phosphate of the adaptor. Therefore, removal of 5′ phosphates from nucleic acid fragments can minimize aberrant ligation of two library members. Accordingly, in some embodiments, 5′ phosphates are removed from nucleic acid fragments. In some embodiments, 5′ phosphates are removed from at least 50%, 55%, 60%, 65%, 70%, 75%, 80%, 85%, 90%, 95%, or greater than 95% of nucleic acid fragments in a sample. In some embodiments, substantially all phosphate groups are removed from nucleic acid fragments. In some embodiments, substantially all phosphates are removed from at least 50%, 55%, 60%, 65%, 70%, 75%, 80%, 85%, 90%, 95%, or greater than 95% of nucleic acid fragments in a sample. Removal of phosphate groups from a nucleic acid sample can be by any means known in the art. Removal of phosphate groups can comprise treating the sample with heat-labile phosphatase. In some embodiments, phosphate groups are not removed from the nucleic acid sample. In some embodiments ligation of an adaptor to the 5′ end of the nucleic acid fragment is performed.

Denaturation

ssDNA can be prepared from dsDNA fragments prepared by any means in the art or as described herein, by denaturation into single strands. Denaturation of dsDNA can be by any means known in the art, including heat denaturation, incubation in basic pH, denaturation by urea or formaldehyde.

Heat denaturation can be achieved by heating a dsDNA sample to about 60 deg C. or above, about 65 deg C. or above, about 70 deg C. or above, about 75 deg C. or above, about 80 deg C. or above, about 85 deg C. or above, about 90 deg C. or above, about 95 deg C. or above, or about 98 deg C. or above. The dsDNA sample can be heated by any means known in the art, including, e.g., incubation in a water bath, a temperature controlled heat block, a thermal cycler. In some embodiments the sample is heated for 0.5, 1, 2, 3, 4, 5, 6, 7, 8, 9, 10, or more than 10 minutes.

Denaturation by incubation in basic pH can be achieved by, for example, incubation of a dsDNA sample in a solution comprising sodium hydroxide (NaOH) or potassium hydroxide (KOH). The solution can comprise about 1 mM NAOH, about 2 mM NAOH, about 5 mM NAOH, about 10 mM NAOH, about 20 mM NAOH, about 40 mM NAOH, about 60 mM NAOH, about 80 mM NAOH, about 100 mM NAOH, about 0.2M NaOH, about 0.3M NaOH, about 0.4M NaOH, about 0.5M NaOH, about 0.6M NaOH, about 0.7M NaOH, about 0.8M NaOH, about 0.9M NaOH, about 1.0M NaOH, or greater than 1.0M NaOH. The solution can comprise about 1 mM KOH, about 2 mM KOH, about 5 mM KOH, about 10 mM KOH, about 20 mM KOH, about 40 mM KOH, about 60 mM KOH, about 80 mM KOH, about 100 mM KOH, about 0.2M KOH, about 0.5M KOH, about 1M KOH, or greater than 1M KOH. In some embodiments, the dsDNA sample is incubated in NaOH or KOH for 0.5, 1, 2, 3, 4, 5, 6, 7, 8, 9, 10, 15, 20, 30, 40, 50, 60, or more than 60 minutes. The dsDNA can be incubated with sodium or ammonium salts of acetic acid, or acetic acid following NaOH or KOH incubation to neutralize the alkaline solution.

Compounds like urea and formamide contain functional groups that can form H-bonds with the electronegative centers of the nucleotide bases. At high concentrations (e.g., 8M urea or 70% formamide) of the denaturant, the competition for H-bonds can favor interactions between the denaturant and the N-bases rather than between complementary bases, thereby separating the two strands. The term “separating” can refer to physical separation of two elements (e.g., by cleavage, hydrolysis, or degradation of one of the two elements).

Ligation of Adaptor to 3′ End of Nucleic Acid Fragments

An adaptor can be ligated onto one or both ends of a nucleic acid fragment (e.g., ssDNA, DNA, RNA). The adaptor can be ligated onto a 5′ end and/or a 3′ end. In some cases, the adaptor is ligated onto a 3′ end of the nucleic acid fragment.

The adaptor can comprise a sequence that acts as a template for annealing a primer. The sequence of the adaptor can comprise a sequence that is at least 70%, 80%, 90%, or 100% complementary to a portion or all of an adaptor sequence for coupling to an NGS (massively parallel sequencing) platform (NGS adaptor; e.g., flow cell sequence). The adaptor can comprise a sequence complementary or identical to at least 5, 6, 7, 8, 9, 10, 11, 12, 13, 14, 15, 20, or more than 20 contiguous nucleotides of an NGS adaptor. In some cases, the adaptor does not comprise a sequence complementary to, or identical to, a portion or all of an NGS adaptor (e.g., a flow cell sequence).

The adaptor can be adenylated at a 5′ end. The adaptor can be conjugated to a capture moiety that is capable of forming a complex with a capture reagent. The capture moiety can be conjugated to the adaptor oligonucleotide by any means known in the art. Capture moiety/capture reagent pairs are known in the art. In some cases the capture reagent is avidin, streptavidin, or neutravidin and the capture moiety is biotin. In another case the capture moiety/capture reagent pair is digoxigenin/wheat germ agglutinin.

In some cases, the adaptor is ligated to a nucleic acid fragment. Ligation of the adaptor to the nucleic acid fragment can be effected by an ATP-dependent ligase. The ATP-dependent ligase can be an RNA ligase. The RNA ligase can be an ATP dependent ligase. The RNA ligase can be an Rnl 1 or Rnl 2 family ligase. Rnl 1 family ligases can repair single-stranded breaks in tRNA. Exemplary Rnl 1 family ligases include, e.g., T4 RNA ligase, thermostable RNA ligase 1 from Thermus scitoductus bacteriophage TS2126 (CircLigase), or CircLigase II. These ligases can catalyze the ATP-dependent formation of a phosphodiester bond between a nucleotide 3-OH nucleophile and a 5′ phosphate group. Rnl 2 family ligases can seal nicks in duplex RNAs. Exemplary Rnl 2 family ligases include, e.g., T4 RNA ligase 2. The RNA ligase can be an Archaeal RNA ligase, e.g., an archaeal RNA ligase from the thermophilic archaeon Methanobacterium thermoautotrophicum (MthRnl).

The ligation of the adaptor to the single-stranded nucleic acid fragment can comprise preparing a reaction mixture comprising a nucleic acid fragment, an adaptor, and ligase. The reaction mixture can be heated to effect ligation of the adaptor oligonucleotides to the ss DNA fragments. The reaction mixture can be heated to about 50 deg C., about 55 deg C., about 60 deg C., about 65 deg C., about 70 deg C., or above 70 deg C. The reaction mixture can be heated to about 60-70 deg C. The reaction mixture can be heated for a sufficient time to effect ligation of the adaptor to the nucleic acid fragment. The reaction mixture can be heated for about 5 min, about 10 min, about 15 min, about 20 min, about 25 min, about 30 min, about 35 min, about 40 min, about 45 min, about 50 min, about 55 min, about 60 min, about 70 min, about 80 min, about 90 min, about 120 min, about 150 min, about 180 min, about 210 min, about 240 min, or more than 240 min.

An adaptor can be present in the reaction mixture in a concentration that is greater than the concentration of nucleic acid fragments in the mixture. In some embodiments, the adaptors are present at a concentration that is at least 10%, 20%, 30%, 40%, 60%, 60%, 70%, 80%, 90%, 100% or more than 100% greater than the concentration of nucleic acid fragments in the mixture. The adaptors can be present at concentration that is at least 10-fold, 100-fold, 1000-fold, or 10000-fold greater than the concentration of nucleic acid fragments in the mixture. The adaptors can be present at a final concentration of at least 0.1 uM, at least 0.5 uM, at least 1 uM, at least 10 uM or greater. The ligase can be present in the reaction mixture at a saturating amount.

The reaction mixture can additionally comprise a high molecular weight inert molecule, e.g., PEG of MW 4000, 6000, or 8000. The inert molecule can be present in an amount that is about 0.5%, 1%, 2%, 3%, 4%, 5%, 7.5%, 10%, 12.5%, 15%, 17.5%, 20%, 25%, 30%, 35%, 40%, 45%, 50%, or greater than 50% weight/volume. In some embodiments, the inert molecule is present in an amount that is about 0.5-2%, about 1-5%, about 2-15%, about 10-20%, about 15-30%, about 20-50%, or more than 50% weight/volume.

After sufficient time has occurred to effect ligation of adaptors to the ss nucleic acid molecules (e.g., ss DNA fragments), unreacted adaptors can be removed by any means known in the art, e.g., filtration by molecular weight cutoff, size exclusion chromatography, use of a spin column, selective precipitation with polyethylene glycol (PEG), selective precipitation with PEG onto a silica or carboxylate matrix, alcohol precipitation, sodium acetate precipitation, PEG and salt precipitation, or high stringency washing.

In some cases, ligated nucleic acid fragments can be captured. Capturing of the ligated nucleic acid fragment can occur prior to extension or subsequent to extension. The ligated nucleic acid fragment can be captured onto a solid support. Capturing can involve the formation of a complex comprising a capture moiety conjugated to an adaptor and a capture reagent. The capture reagent can be immobilized onto a solid support. The solid support can comprise an excess of capture reagent as compared to the amount of ligated nucleic acid comprising the capture moiety. The solid support can comprise 5-fold, 10-fold, or 100-fold more available binding sites that the total number of ligated nucleic acid fragments comprising the capture moiety.

In some cases, e.g., when a single-stranded adaptor is ligated to a 3′ end of a single-stranded fragment (e.g., ssDNA fragment), a primer (e.g., adaptor-specific primer) is hybridized to the ligated nucleic acid fragment via the adaptor. The primer (e.g., adaptor-specific primer) can comprise a 3′ sequence that anneals to the adaptor at the 3′ end of the single-stranded fragment.

The primer (e.g., adaptor-specific primer) can comprise a portion or entirety of an NGS adaptor sequence, e.g., at its 5′ end. Exemplary NGS adaptor sequences are described herein. The hybridized primer can be extended to create a duplex comprising the original nucleic acid fragment and the extended primer, wherein the extended primer comprises a reverse complement of the original nucleic acid fragment and an NGS adaptor sequence at one end. Exemplary NGS adaptor sequences are described herein. In some embodiments, the NGS adaptor sequence in the primer comprises a sequence that is at least 70%, 80%, 90%, or 100% identical to a surface-bound oligonucleotide (e.g., flow cell sequence) of an NGS platform. The NGS adaptor sequence can comprise a sequence that is at least 70%, 80%, 90%, or 100% complementary to a surface-bound oligonucleotide (e.g., flow cell sequence) of an NGS platform. The NGS adaptor sequence can comprise a sequence that is at least 70%, 80%, 90%, or 100% identical to a sequencing primer for use by an NGS platform. The NGS adaptor sequence can comprise a sequence that is at least 70%, 80%, 90%, or 100% complementary to a sequencing primer for use by an NGS platform. Extension of the adaptor primer can be effected by a proofreading mesophilic or thermophilic DNA polymerase. The polymerase can be a thermophilic polymerase with 5′-3′ exonucleolytic/endonucleolytic (DNA polymerases I, II, III) or 3′-5′ exonucleolytic (family A or B DNA polymerases, DNA polymerase I, T4 DNA polymerase) activity. In some instances, the polymerase can have no exonuclease activity (Taq). The polymerase can effect linear amplification of the immobilized ligated fragment, creating a plurality of copies of the reverse complement of the immobilized ligated fragment. In some cases, only one copy of the reverse complement is created. In some embodiments, the extended primer molecules are separated from the original nucleic acid template (e.g., by denaturation, e.g., as described herein). The extended primer molecules can be free in solution while the original nucleic acid template molecules remain immobilized to the solid support. The extended primer molecules can be harvested, resulting in a nucleic acid library preparation in which library members comprise an NGS adaptor. At least 50%, 60%, 70%, 80%, 90%, more than 90%, or substantially all of the library members can comprise an NGS adaptor.

An exemplary method for preparing a nucleic acid library from nucleic acids (e.g., DNA or RNA) isolated from a biological sample (e.g., a blood, plasma, urine, stool, mucosal sample) is provided below. The nucleic acids obtained can be fragmented by enzymatic or mechanical means to about 100 to about 1000, e.g., about 100 to about 500 bp fragments. The nucleic acids can be fragmented in situ. Nucleic acids can be fragmented from formalin-fixed paraffin-embedded (FFPE) tissues or circulating DNA. Nucleic acids can be isolated from FFPE and circulating by kits (Qiagen, Covaris). The nucleic acids can be DNA. The DNA can be cDNA generated from RNA isolated from a biological sample from the same samples using random primed reverse transcription (RNaseH+) to generate randomly sized cDNA. The nucleic acid can be RNA. Fragmented DNA can be treated with a base excision repair enzyme (e.g., Endo VIII, formamidopyrimidine DNA glycosylase (FPG)) to excise damaged bases that can interfere with polymerization. DNA can then be treated with a proof-reading polymerase (e.g., T4 DNA polymerase) to polish ends and replace damaged nucleotides (e.g., abasic sites). In some embodiments, DNA is not treated with a proof-reading polymerase to polish ends and replace damaged nucleotides.

The nucleic acids (e.g., DNA or RNA) can be treated with heat-labile phosphatase to remove phosphate groups from the nucleic acids. The reaction mixture can be heated to 80 deg C. for 10 min to inactivate the phosphatase and polymerase and denature double stranded DNA to single strands.

A chemically or enzymatically phosphorylated adaptor, with or without a 3′-end affinity tag (e.g., biotin) about 12 to about 50 bases in length can be ligated to the 3′ end of fragmented single-strand nucleic acids at a final concentration of 0.5 uM or greater with saturating amount of ATP-dependent RNA ligase (e.g., T4 RNA ligase, a thermophilic such as CircLigase, CircLigase II), e.g., in the presence of 10-20% (w/v) polyethylene glycol of average molecular weight 4000, 6000, or 8000. The reaction can be incubated for 1 hr @ about 60 to about 70 deg. C. The adaptor can comprise the following: (i) all, part or none of the sequence corresponding to a surface-bound oligonucleotide for Illumina flow cell cluster generation (ii) a 3′-end affinity group that is incapable of participating in the ligation reaction that is linked to the oligonucleotide at a sufficient distance (e.g., 10 atoms or greater) to minimize steric hindrance of the interaction between the affinity ligand and the bound receptor.

The adaptor can be adenylated by any means known in the art. If an adenylated adaptor is used, in some embodiments the ATP-dependent RNA ligase is not CircLigase or CircLigase II. In some cases, an ATP-dependent RNA ligase is not required. The reaction can be purified by size to remove unreacted adaptor. Purification can be achieved through the use of a microfiltration unit with a molecular size cutoff of 10K or 3K (e.g., microcon YM-10 or YM3, or nanosep omega). Adaptor removal can be achieved through passage through a size exclusion desalting column (agarose, polyacrylamide) with a size exclusion cutoff, e.g., of 10K or less, through the use of a spin column, through selective precipitation with PEG, alcohol or salt, high stringency washing, or denaturing gel electrophoresis.

An oligonucleotide primer either fully complementary to the adaptor or partially complementary to the adaptor at its 3′-end, can comprise the sequence corresponding to a sequence on a flow cell, e.g., an Illumina flow-cell oligonucleotide, can be used to create a reverse complement of the bound library using a proofreading mesophilic DNA polymerase. A thermophilic polymerase with 5′-3′ exonucleolytic/endonucleolytic (e.g., Family A DNA polymerase, e.g., DNA polymerase I) or 3′-5′ exonucleolytic (e.g., family B DNA polymerases, Vent, Phusion, Pfu and their variants) activity can be used to permit linear amplification of the library.

In some cases, the recovered material can then be bound to an affinity resin or support capable of binding to the 3′-end affinity tag in batch mode. The recovered material can be put into a pre-rinsed support in a 0.2 ml tube containing at least 10-fold excess, or 100-fold more available binding sites that the total number of tagged adaptor molecules.

The supernatant consisting of copies of the bound library can be harvested and quantified.

In one example, dsDNA is fragmented. dsDNA fragments can be dephosphorylated and heat-denatured into single strands. Biotinylated adaptors comprising a primer-docking sequence can be contacted with the nucleic acid fragments. The adaptors can be ligated to the 3′ ends of the ssDNA fragments to create library member precursors. Primers comprising sequence complementary to the adaptor and and additional adaptor sequence (e.g., at the 5′ end of the primer) can be hybridized to the ssDNA via the ligated adaptors. The hybridized primers can be extended along the template ssDNA fragments to create duplexes. The duplexes can be immobilized onto a solid support (e.g., streptavidin coated beads). Heat denaturation can release the final library members into solution while retaining the original ssDNA fragment on the bead.

### G. ssDNA Library Preparation (Attaching Adaptor to Both Ends of a Fragment)

Provided herein are methods, compositions, and kits for preparing a ssDNA library, comprising denaturing dsDNA fragments into ssDNA, and ligating adaptor sequences to both ends of the ssDNA molecules. Methods of fragmenting dsDNA are described herein. Methods of denaturing dsDNA fragments are described herein.

The method can comprise ligating a first adaptor that comprises a sequence that is at least 70%, 80%, 90%, or 100% complementary or identical to a first surface-bound oligonucleotide (e.g., a sequencing instrument flow-cell oligonucleotide). The first surface-bound oligonucleotide can be an NGS platform-specific surface bound oligonucleotide. The first adaptor can comprise a sequence complementary or identical to about 5, 6, 7, 8, 9, 10, 11, 12, 13, 14, 15, 20, or more than 20 contiguous nucleotides of the surface-bound oligonucleotide. The first adaptor can further comprise a sequence that is at least 70%, 80%, 90%, or 100% complementary to a first sequencing primer. The first adaptor can be ligated to a 3′ end of an ssDNA fragment using a method described herein or any method known in the art. The ssDNA fragment can lack 5′ phosphate groups. The first adaptor can be ligated to the 3′ end of the ssDNA fragment by an ATP-dependent ligase. The first adaptor can comprises a 3′ terminal blocking group. The 3′ terminal blocking group can prevent the formation of a covalent bond between the 3′ terminal base and another nucleotide. The 3′ terminal blocking group can be dideoxy-dNTP or biotin. The first adaptor can be 5′ adenylated. The first adaptor can be ligated to a 3′ end of an ssDNA fragment by an RNA ligase as described herein. The RNA ligase can be truncated or mutated RNA ligase 2 from T4 or Mth. The method can further comprises ligating a second adaptor sequence to a 5′ end of the ssDNA fragment. The second adaptor sequence can be distinct from the first adaptor sequence. The second adaptor sequence can comprise a sequence that is at least 70% complementary to a second surface-bound oligonucleotide. The second surface-bound oligonucleotide can be an NGS platform-specific surface bound oligonucleotide. The second adaptor can comprise a sequence complementary or identical to about 5, 6, 7, 8, 9, 10, 11, 12, 13, 14, 15, 20, or more than 20 contiguous nucleotides of the surface-bound oligonucleotide. The second adaptor can further comprise a sequence that is at least 70%, 80%, 90%, or 100% complementary to a second sequencing primer. The second adaptor can be ligated to the ssDNA fragment using RNA ligase, e.g., CircLigase as described herein. The first and second adaptor can both be at least 70%, 80%, 90%, or 100% complementary to the first and second surface-bound oligonucleotides. The first and second adaptor can be both at least 70%, 80%, 90%, or 100% identical to the first and second surface-bound oligonucleotides.

A ssDNA library produced using methods described herein can be used for whole genome sequencing or targeted sequencing. In some embodiments, the ssDNA library produced using methods described herein are enriched for target polynucleotides of interest prior to sequencing.

### H. ssDNA Library Formation: Target Specific Library Enrichment

Provided herein are methods, compositions, and kits for preparing a target-enriched nucleic acid library. The method can involve hybridizing a target-selective oligonucleotide (TSO) to a single stranded DNA (ssDNA) fragment to create a hybridization product, and extension to create an extension strand.

The method of target enrichment can be as described in US. Patent Application Pub. No. 20120157322, hereby incorporated by reference.

The hybridizing and amplifying can occur in a reaction mixture. The term “reaction mixture” as used herein can refer to a mixture of components to amplify at least one amplicon from nucleic acid template molecules. The mixture can comprise nucleotides (dNTPs), a polymerase and a target-selective oligonucleotide. the mixture can comprise a plurality of target-selective oligonucleotides. The mixture can further comprise a Tris buffer, a monovalent salt, and Mg2+. The concentration of each component can be further optimized by an ordinary skilled artisan. The reaction mixture can also comprise additives including, but not limited to, non-specific background/blocking nucleic acids (e.g., salmon sperm DNA), biopreservatives (e.g. sodium azide), PCR enhancers (e.g. Betaine, Trehalose, etc.), and inhibitors (e.g. RNAse inhibitors). A nucleic acid sample (e.g., a sample comprising an ssDNA fragment) can be admixed with the reaction mixture. A reaction mixture can further comprise a nucleic acid sample.

The ssDNA fragment can be a member of an ssDNA library. The ssDNA library can be prepared using a method as described herein. The ssDNA fragment can comprise a first single-stranded adaptor sequence located at a first end but not at a second end. The first end can be a 5′ end. The TSO can comprise a second single-stranded adaptor sequence located at a first end but not a second end. The first end can be a 5′ end. The first adaptor sequence can comprise a sequence that is at least 70%, 80%, 90%, or 100% complementary or identical to a first surface-bound oligonucleotide (e.g., a flow-cell oligonucleotide). The first adaptor sequence can comprise a sequence that is at least 70%, 80%, 90%, or 100% complementary or identical to a sequencing primer. The first adaptor can comprise a barcode sequence. The second adaptor can comprise a sequence that is at least 70%, 80%, 90%, or 100% identical to a second surface-bound oligonucleotide (e.g., flow-cell sequence). The second adaptor sequence can comprise a sequence that is at least 70%, 80%, 90%, or 100% identical to a sequencing primer.

The target-selective oligonucleotide (TSO) can be designed to at least partially hybridize to a target polynucleotide of interest. The TSO can be designed to selectively hybridize to the target polynucleotide. The TSO can be at least about 70%, 75%, 80%, 85%, 90%, 95%, or more than 95% complementary to a sequence in the target polynucleotide. The TSO can be 100% complementary to a sequence in the target polynucleotide. The hybridization can result in a TSO/target duplex with a Tm. The Tm of the TSO/target duplex can be between 0 and about 100 deg C., between about 20 and about 90 deg C., between about 40 and about 80 deg C., between about 50 and about 70 deg C., between about 55 and about 65 deg C. or between about 62 and about 68 deg C. The TSO can be sufficiently long to prime the synthesis of extension products in the presence of a polymerase. The exact length and composition of a TSO can depend on many factors, including temperature of the annealing reaction, source and composition of the primer, and ratio of primer: probe concentration. The TSO can be, for example, about 8 to about 50 nts, about 10 to about 40 nts, or about 12 to about 24 nts in length. The TSO can be about 40 nt in length. In some cases, the portion of the TSO that binds a target sequence is about 10 to about 50 nt, about 20 to about 50 nt, about 25 to about 40 nt, about 30 to about 40 nt, or about 35 to about 40 nt.

A TSO annealed to a target sequence can be extended. Amplification can be carried out utilizing a nucleic acid polymerase. The nucleic acid polymerase can be a DNA polymerase. The DNA polymerase can be a thermostable DNA polymerase. The polymerase can be a member of A or B family DNA proofreading polymerases (Vent, Pfu, Phusion, and their variants), a DNA polymerase holoenzyme (DNA pol III holoenzyme), a Taq polymerase, or a combination thereof.

Extension can be carried out as an automated process wherein the reaction mixture comprising template DNA is cycled through a denaturing step, a primer annealing step, and a synthesis step. The automated process can be carried out using a PCR thermal cycler. Commercially available thermal cycler systems include systems from Bio-Rad Laboratories, Life technologies, Perkin-Elmer, among others.

A TSO annealed to a target sequence can be extended to generate an extension product comprising an extended strand comprising the second adaptor sequence, the TSO, a reverse complement of the target sequence, and a reverse complement of the first adaptor sequence. If the first adaptor sequence of the original ssDNA fragment was 70% or more identical to a first surface-bound oligonucleotide, then the extended strand can comprise a first adaptor sequence that is 70% or more complementary to the first surface-bound oligonucleotide, and can be hybridizable to a first surface-bound oligonucleotide (e.g., a flow-cell oligonucleotide). The extended strands can comprise the target-enriched library.

The extension products annealed to target sequences in a reaction mixture can be denatured. In some cases, the extended strands are subject to amplification, e.g., polymerase chain reaction, before use in a massively parallel sequencing instrument or other application. In some cases, the extended strands are not amplified (e.g., amplified in solution, e.g., using PCR), before use in a massively parallel sequencing instrument or other application. In some cases, the extended strands are subject to PCR for about 5 to about 50 cycles, about 5 to about 40 cycles, about 5 to about 30 cycles, about 5 to about 25 cycles, about 5 to about 20 cycles, or about 5 to about 15 cycles, e.g., in solution, before use in a massively parallel sequencing instrument. In some cases, the extended strands are subject amplification, e.g., PCR, for less than 40 cycles, less than 30 cycles, less than 25 cycles, less than 20 cycles, less than 15 cycles, less than 14 cycles, less than 13 cycles, less than 12 cycles, less than 11 cycles, or less than 10 cycles, e.g., in solution, before use in a massively parallel sequencing instrument. The extended strands can be amplified, e.g., by PCR for about 5, 6, 7, 8, 9, 10, 11, 12, 13, 14, 15, 16, 17, 18, 19, or 20 cycles, e.g., in solution, before use in a massively parallel sequencing instrument. The amplification can be performed with a first primer that anneals to the complement of the first adaptor sequence (e.g., a primer with sequence identical to adaptor sequence at the 5′ end of the target sequence) and a second primer that anneals to the complement of the second adaptor sequence (e.g., a primer with sequence identical to second adaptor sequence at the 5′ end of the TSO).

The denatured extension products, and/or amplified versions thereof, can be contacted with a surface immobilized thereon with at least a first surface-bound oligonucleotide (e.g., a flow-cell sequence). The extended strand can be captured by the first surface-bound oligonucleotide (e.g., flow-cell oligonucleotide), which can anneal to the first adaptor sequence on the extended strand.

The first surface-bound oligonucleotide can prime the extension of the captured extended strand. Extension of the captured extended strand can result in a captured extension product. The captured extension product can comprises the first surface bound oligonucleotide, the target sequence, and the complement of the second adaptor sequence that is at least 70%, 80%, 90%, or 100% more complementary to a second surface-bound oligonucleotide.

The captured extension product can hybridize to a second surface-bound oligonucleotide, forming a bridge. In some embodiments, the bridge is amplified by bridge PCR. Bridge PCR methods can be carried out using methods known to the art.

### I. Kits for Library Preparation and Target Enrichment

Also provided are kits for practicing a method of library preparation as described herein or target-enrichment as described herein.

The kit can comprise reagents for repairing and chemical denaturation of dsDNA. The kit can comprise reagents for purification of single-stranded DNA. The kit can comprise one or more enzymes for excision of damaged bases. The kit can comprise a phosphatase. The kit can comprise a kinase. The kit can comprise a terminal transferase and dideoxynucleotides to block the 3′-end of DNA fragments.

Provided herein are kits for preparing a ssDNA library. The kit comprises an adaptor, e.g., as described herein. The kit can comprise instructions, e.g., instructions for ligating an adaptor to a ssDNA fragment. The kit can further comprise a ligase. The ligase can be an Rnl 1 or Rnl 2 family ligase. The kit can further comprise a primer which can hybridize to the adaptor. Primers hybridizable to the adaptor are described herein. The kit can provide a solid support, e.g., a bead immobilized thereon a capture reagent. The kit can provide a polymerase for conducting an extension reaction. The kit can provide dNTPs for conducting an extension reaction.

The kit can comprise a first adaptor oligonucleotide that comprises sequence that is at least 70%, 80%, 90%, or 100% complementary or identical to a first support-bound oligonucleotide coupled to a sequencing platform, a second adaptor oligonucleotide that comprises a sequence that is distinct from the first adaptor, an RNA ligase, and instructions for use. The first adaptor can comprise a 3′ terminal blocking group that prevents the formation of a covalent bond between the 3′ terminal base and another nucleotide. 3′ terminal blocking groups are described herein. The first adaptor can be 5′ adenylated. The first adaptor can comprise a sequence that is at least 70%, 80%, 90%, or 100% complementary or identical to a sequencing primer. The second adaptor can comprise a sequence that is at least 70%, 80%, 90%, or 100% complementary or identical to a sequencing primer. The second adaptor can comprise a sequence that is at least 70%, 80%, 90%, or 100% complementary to a second support-bound oligonucleotide coupled to a sequencing platform.

Also provided are kits for preparing a target-enriched DNA library. The kit can comprise an adaptor, a ligase, a primer that can hybridize to the target-specific sequence, a solid support comprising a capture reagent, a polymerase, dNTPs, or any combination thereof. The TSO can be free in solution or immobilized on a solid support coupled for sequencing on an NGS platform, as described in US Patent Application Pub No. 20120157322, hereby incorporated by reference.

Kits provided herein can include a packaging material. The term “packaging material” can refer to a physical structure housing the components of the kit. The packaging material can maintain sterility of the kit components, and can be made of material commonly used for such purposes (e.g., paper, corrugated fiber, glass, plastic, foil, ampules, etc.). Kits can also include a buffering agent, a preservative, or a protein/nucleic acid stabilizing agent.

The disclosure provided herein can include employ techniques of molecular biology, microbiology and recombinant DNA techniques that are within the skill of the art. See, e.g., Sambrook, Fritsch & Maniatis, Molecular Cloning: A Laboratory Manual, Fourth Edition (2012); Oligonucleotide Synthesis (M. J. Gait, ed., 1984); Nucleic Acid Hybridization (B. D. Hames & S. J. Higgins, eds., 1984); A Practical Guide to Molecular Cloning (B. Perbal, 1984); and a series, Methods in Enzymology (Academic Press, Inc.). All patents, patent applications, and publications mentioned herein, both supra and infra, are hereby incorporated by reference.

### IX. Patient Monitoring

The computing systems, software media, methods and kits provided herein can be used for monitoring patients e.g., a longitudinal assay. The method can comprise sequencing e.g., massively parallel sequencing (next generation sequencing) one or more genes from an initial tumor sample, e.g. a formalin-fixed paraffin embedded (FFPE) sample, a fine needle aspirate (FNA) biopsy, a core needle biopsy (CNB), and/or a cell-free sample (e.g., cell-free plasma sample). An initial sample can be a sample taken from a subject before the subject receives a cancer treatment. When plasma is used as an initial sample, the amount of DNA used from the sample can be about 1 ng of DNA. When plasma is used as an initial sample, the volume of plasma can be about 3 mL. In some cases, only a solid tumor sample (e.g., FFPE sample, FNA sample, or CNB sample) for sequencing is obtained from a subject before the subject receives a cancer treatment, and nucleic acid from the sample is sequenced. In some cases, only a fluid sample (e.g., plasma) for sequencing is taken from a subject before the subject receives a cancer treatment, and nucleic acid is sequenced from the fluid (e.g., plasma) sample. In some cases, both a solid tumor sample and a fluid sample (e.g., plasma) for sequencing are taken from a subject before the subject receives a cancer treatment, and nucleic acid is sequenced from the solid tumor sample and the fluid (e.g., plasma) sample. Sequencing data from the solid tumor sample and fluid sample taken before the subject receives a cancer treatment can be compared. In some cases, sequencing data from a solid tumor sample and fluid sample taken before the subject receives a cancer treatment are not compared.

The number of genes sequenced in a sample (e.g., initial sample) can be about, or at least 1, 5, 10, 20, 30, 40, 50, 60, 70, 80, 90, 96, 100, 110, 120, 129, 130, 140, 150, 160, 170, 180, 190, 200, 300, 400, 500, 600, 700, 800, 900 or more genes. The sequencing can occur in a Clinical Laboratory Improvement Amendments (CLIA) certified laboratory and/or College of American Pathologists (CAP) certified laboratory. Analysis of the sequencing data (e.g., bioinformatics) can occur in a CLIA and/or CAP certified laboratory. The genes sequenced can be one or more of the following: ABCA1, BRAF, CHD5, EP300, FLT1, ITPA, MYC, PIK3R1, SKP2, TP53, ABCA7, BRCA1, CHEK1, EPHA3, FLT3, JAK1, MYCL1, PIK3R2, SLC19A1, TP73, ABCB1, BRCA2, CHEK2, EPHA5, FLT4, JAK2, MYCN, PKHD1, SLC1A6, TPM3, ABCC2, BRIP1, CLTC, EPHA6, FN1, JAK3, MYH2, PLCB1, SLC22A2, TPMT, ABCC3, BUB1B, COL1A1, EPHA7, FOS, JUN, MYH9, PLCG1, SLCO1B3, TPO, ABCC4, Clorf144, COPS5, EPHA8, FOXO1, KBTBD11, NAV3, PLCG2, SMAD2, TPR, ABCG2, CABLES1, CREB1, EPHB1, FOXO3, KDM6A, NBN, PML, SMAD3, TR10, ABL1, CACNA2D1, CREBBP, EPHB4, FOXP4, KDR, NCOA2, PMS2, SMAD4, TRRAP, ABL2, CAMKV, CRKL, EPHB6, GAB1, KIT, NEK11, PPARG, SMARCA4, TSC1, ACVR1B, CARD11, CRLF2, EPO, GATA1, KLF6, NF1, PPARGC1A, SMARCB1, TSC2, ACVR2A, CARM1, CSF1R, ERBB2, GLI1, KLHDC4, NF2, PPP1R3A, SMO, TTK, ADCY9, CAV1, CSMD3, ERBB3, GLI3, KRAS, NKX2-1, PPP2R1A, SOCS1, TYK2, AGAP2, CBFA2T3, CSNK1G2, ERBB4, GNA11, LMO2, NOS2, PPP2R1B, SOD2, TYMS, AKT1, CBL, CTNNA1, ERCC1, GNAQ, LRP1B, NOS3, PRKAA2, SOS1, UGT1A1, AKT2, CCND1, CTNNA2, ERCC2, GNAS, LRP2, NOTCH1, PRKCA, SOX10, UMPS, AKT3, CCND2, CTNNB1, ERCC3, GPR124, LRP6, NOTCH2, PRKCZ, SOX2, USP9X, ALK, CCND3, CYFIP1, ERCC4, GPR133, LTK, NOTCH3, PRKDC, SP1, VEGF, ANAPC5, CCNE1, CYLD, ERCC5, GRB2, MAN1B1, NPM1, PTCH1, SPRY2, VEGFA, APC, CD40LG, CYP19A1, ERCC6, GSK3B, MAP2K1, NQO1, PTCH2, SRC, VHL, APC2, CD44, CYP1B1, ERG, GSTP1, MAP2K2, NR3C1, PTEN, ST6GAL2, WRN, AR, CD79A, CYP2C19, ERN2, GUCY1A2, MAP2K4, NRAS, PTGS2, STAT1, WT1, ARAF, CD79B, CYP2C8, ESR1, HDAC1, MAP2K7, NRP2, PTPN11, STAT3, XPA, ARFRP1, CDC42, CYP2D6, ESR2, HDAC2, MAP3K1, NTRK1, PTPRB, STK11, XPC, ARID1A, CDC42BPB, CYP3A4, ETV4, HGF, MAPK1, NTRK2, PTPRD, SUFU, ZFY, ATM, CDC73, CYP3A5, EWSR1, HIF1A, MAPK3, NTRK3, RAD50, SULT1A1, ZNF521, ATP5A1, CDH1, DACH2, EXT1, HM13, MAPK8, OMA1, RAD51, SUZ12, ATR, CDH10, DCC, EZH2, HMGA1, MARK3, OR10R2, RAFT, TAF1, AURKA, CDH2, DCLK3, FANCA, HNF1A, MCL1, PAK3, RARA, TBX22, AURKB, CDH2O, DDB2, FANCD2, HOXA3, MDM2, PARP1, RB1, TCF12, BAI3, CDH5, DDB2, FANCE, HOXA9, MDM4, PAX5, REM1, TCF3, BAP1, CDK2, DGKB, FANCF, HRAS, MECOM, PCDH15, RET, TCF4, BARD1, CDK4, DGKZ, FAS, HSP90AA1, MEN1, PCDH18, RICTOR, TEK, BAX, CDK6, DIRAS3, FBXW7, IDH1, MET, PCNA, RIPK1, TEP1, BCL11A, CDK7, DLG3, FCGR3A, IDH2, MITF, PDGFA, ROR1, TERT, BCL2, CDK8, DLL1, FES, IFNG, MLH1, PDGFB, ROR2, TET2, BCL2A1, CDKN1A, DNMT1, FGFR1, IGF1R, MLL, PDGFRA, ROS1, TGFBR2, BCL2L1, CDKN1B, DNMT3A, FGFR2, IGF2R, MLL3, PDGFRB, RPS6KA2, THBS1, BCL2L2, CDKN2A, DNMT3B, FGFR3, IKBKE, MPL, PDZRN3, RPTOR, TNFAIP3, BCL3, CDKN2B, DOT1L, FGFR4, IKZF1, MRE11A, PHLPP2, RSPO2, TNKS, BCL6, CDKN2C, DPYD, FH, IL2RG, MSH2, PIK3C3, RSPO3, TNKS2, BCR, CDKN2D, E2F1, FHOD3, INHBA, MSH6, PIK3CA, RUNX1, TNNI3K, BIRCS, CDX2, EED, FIGF, INSR, MTHFR, PIK3CB, SDHB, TNR, BIRC6, CEBPA, EGF, FLG2, IRS1, MTOR, PIK3CD, SF3B1, TOP1, BLM, CERK, EGFR, FLNC, IRS2, MUTYH, PIK3CG, SHC1, and TOP2A.

The sequence data can be used to determine a profile of mutations in the genes. The profile of mutations can be listed in a report. The report can be provided to a caregiver or to the subject from whom one or more samples were taken. The report can indicate potential therapeutic options based on the profile of mutations.

A subsequent sample can be taken from a subject after the initial sample is taken, e.g., to monitor one or more genes sequenced in an initial sample. A plurality of subsequent samples can be taken from the subject (e.g., about, or at least 2, 3, 4, 5, 6, 7, 8, 9, 10, 20, 30, 40, 50, 60, 70, 80, 90, 100 samples). The subsequent sample from the subject can be a fluid sample, e.g., a plasma sample, or a sample from a solid tumor. Nucleic acid, e.g., cell-free nucleic acid, e.g., cell-free DNA from the subsequent sample can be analyzed. The nucleic acid from the subsequent sample can be analyzed by sequencing, e.g., massively parallel sequencing (next generation sequencing). The nucleic acid in the subsequent sample can be analyzed by amplification, e.g., PCR, e.g., digital PCR (dPCR), e.g., droplet digital PCR (e.g., ddPCR). Nucleic acid in the subsequent sample can be analyzed by both amplification (e.g., dPCR, e.g., ddPCR) and sequencing, e.g., massively parallel sequencing (next generation sequencing).

A subsequent sample can be taken from a subject at a regular interval or an irregular interval. A subsequent sample can be taken from a subject daily, weekly, twice a month, monthly, quarterly, semi-annually, or annually.

In some cases, subsequent samples can be analyzed by sequencing until sequencing no longer provides sufficient sensitivity to detect a mutation or alteration in a gene identified in an initial sample. For example, a mutation can be identified in a gene by sequencing (e.g., using Illumina® MiSeq) of nucleic acid from an initial solid tumor sample or an initial cell-free sample (e.g., plasma), and sequencing can be used to detect a presence or absence of the mutation in the gene in a subsequent sample (e.g., fluid sample, e.g., plasma), and when sequencing is no longer able to detect the mutation in the gene in a subsequent sample, an amplification based assay (e.g., dPCR, e.g., ddPCR using, e.g., a Bio-Rad instrument QX200™ Droplet Digital™ PCR System) can be used to detect a presence or absence of the mutation in the gene in subsequent samples. In some cases, an amplification based method, e.g., dPCR, e.g., ddPCR, can have higher sensitivity than a sequencing based method. In some cases, a mutation detected in an initial sample will be not be detected in a subsequent sample that is analyzed by sequencing, but will be detected in a subsequent sample that is analyzed by amplification, e.g., ddPCR. In some cases, a mutation present in an initial sample will not be detected in a subsequent sample analyzed by sequencing and also not detected in a subsequent sample analyzed by amplification (e.g., ddPCR).

The number of genes analyzed in a subsequent sample can be less than the number of genes analyzed in an initial sample, the same number as analyzed in an initial sample, or more than the number of genes analyzed in the initial sample. The genes analyzed in the subsequent sample can be a subset of the genes analyzed in an initial sample. The genes analyzed in the subsequent sample can be based on a profile of mutations identified in the initial sample (a profile of personalized variants). A number of genes analyzed in a subsequent sample can be about, or at least 1, 5, 10, 20, 30, 40, 50, 60, 70, 80, 90, 96, 100, 110, 120, 129, 130, 140, 150, 160, 170, 180, 190, 200, 300, 400, 500, 600, 700, 800, 900 or more genes. In some cases, a number of genes analyzed in a subsequent sample can be more than a number of genes analyzed in an initial sample. Genes monitored in subsequent samples can be analyzed to monitor the cancer, monitor effectiveness of a treatment, detect evolution of the cancer, detect cancer recurrence, detect cancer relapse, or detect cancer progression.

Subsequent samples can be analyzed for a duration of a cancer in a subject. If a recurrence of cancer is identified in a subsequent sample, a second sample can be taken from the subject and sequenced. The second sample can be a solid sample or fluid sample (e.g., cell-free sample) can be taken from the subject and subjected to sequencing, e.g., massively parallel sequencing (next generation sequencing) to determine a profile of mutations. In some cases, a second sample is a solid tumor sample, and nucleic acid from the solid tumor sample is sequenced.

Sequencing can detect gene amplification, e.g., at least 50%, 60%, 70%, 80%, 90%, 95%, 96%, 97%, 98%, 98.5%, 99%, 99.5%, or 100% of gene amplifications tested. Gene amplifications in a sample can be detected by digital PCR, e.g., ddPCR. Use of ddPCR can detect at least 50%, 60%, 70%, 80%, 90%, 95%, 96%, 97%, 98%, 98.5%, 99%, 99.5%, or 100% of gene amplifications tested. Gene amplifications can be detected using, e.g., fluorescent in-situ hybridization (FISH).

In some embodiments the target-enriched libraries generated as described herein are sequenced using any methods known in the art or as described herein. Sequencing can reveal the presence of mutations in one or more cancer-related genes in the set. In some embodiments a subset of 2, 3, 4 genes harboring the mutations are selected for further monitoring by assessment of cell-free DNA in a fluid sample isolated from the subject at later time points. In some embodiments a subset of no more than 4 genes harboring the mutations are selected for further monitoring by assessment of cell-free DNA in a fluid sample isolated from the subject at later time points.

### X. Definitions

As used in the specification and claims, the singular forms “a”, “an” and “the” can include plural references unless the context clearly dictates otherwise. For example, the term “a cell” can include a plurality of cells, including mixtures thereof.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. The term “about” as used herein refers to a range that is 15% plus or minus from a stated numerical value within the context of the particular usage. For example, about 10 would include a range from 8.5 to 11.5.

Nucleic acids used in the processes described herein can be free in solution. The term “free in solution” can describe a molecule, such as a polynucleotide, that is not bound or tethered to a solid support, e.g., a bead or flow-cell.

Processes described herein can make use of fragments of genomic DNA, or genomic fragments. The term “genomic fragment” can refer to a region of a genome, e.g., an animal or plant genome such as the genome of a human, monkey, rat, fish or insect or plant. A genomic fragment can or can not be adaptor ligated. A genomic fragment can be adaptor ligated (in which case it has an adaptor ligated to one or both ends of the fragment, to at least the 5′ end of a molecule), or non-adaptor ligated.

In certain cases, an oligonucleotide used in the method described herein can be designed using a reference genomic region, i.e., a genomic region of known nucleotide sequence, e.g., a chromosomal region whose sequence is deposited at NCBI's Genbank database or other database, for example.

### EXAMPLES

### Example 1—Identifying Somatic Variants

A subject has a colonoscopy and is discovered to harbor a colon tumor. Both a tumor biopsy and a blood draw are collected from the subject and are used to aid in the diagnosis of colon cancer in the subject. The tumor and normal cells from the first blood draw are sequenced. Sequence comparisons between the tumor and the normal samples of the subject are based on probabilistic models and statistical inferences. The comparison utilizes known chromosomal loci of tumor mutations reported in a public database, and the possible sequences in the neighborhoods of the loci are modeled probabilistically. The model is joined with sequence data of the subject to perform statistical inference. The inference identifies three somatic variant, point mutations in the APC, KRAS, and TP53 genes. The stage of the subject's cancer is determined.

Further, the data analysis application recommends a first treatment strategy, e.g., a surgery to remove the tumor. Upon the first treatment, a second blood draw is performed. It is determined that the subject's tumor has metastasized. The subject is administered as second therapy (chemotherapy) to manage the cancer.

### Example 2—Data Analysis by a Bayesian Network

FIG. 8 shows an exemplary Bayesian network describing the inference for target use cases. In the network diagram, nodes “C” represent variant calls to be inferred, nodes “R” represent base calls of the set of aligned reads across the locus, nodes “P” are the ploidy at the locus (e.g. diploid for the normal germline, but could be different in the cancer cells due to genomic instability). In the case of the samples that include cancer tumor cells or DNA, “U” represents the cellularity of the sample, that can be estimated by other means (e.g. pathology), and is indicated as the probability that a DNA molecule from the germline is present in the tumor sample, and provided as a value between 0 to 1.

Suitable values can be supplied for the following Conditional Probability Distributions (CPDs): (a) P(R|C), the probability of a set of reads given a particular variant call, (b) P(Cₜ|C_{g}) the probability of a primary tumor call given those of the germline at that locus, and (c) P(C_{cf}|Cₜ) the probability of a tumor call in the cell-free DNA (cf-DNA) given the call in the primary tumor sample.

The CDP P(R|C) can be part of the standard Bayesian variant calling methodology for a single sample. The second two CDPs can be computed by utilizing empirical values for somatic mutation rates that can be adjusted per tumor type and predominant mutational signatures. In the case of P(Cₜ|C_{g}), and by assuming a simple lineage relationship between primary tumor and the tumor DNA detected in the cell-free fraction of the patient's plasma, this CDP can be computed, e.g., in analogy with computations carried out in pedigrees including the inference of de novo mutations in offspring assuming simple inheritance of variants rather than Mendelian segregation.

In addition, site and allele specific prior values can be introduced for specific loci based on prior germline variant observations by population sequencing, or large scale census of somatic mutation across tumor types such as the TCGA project. These can be useful in the absence of some of the tissue samples from the patient (e.g. germline or primary tissue). One case is when only primary tumor tissue or only cf-DNA from plasma fraction are being analyzed. In this situation prior information can be used to estimate the CDPs P(Cₜ|Cₜₚ), where Cₜₚ is the prior probability of observing a specific somatic mutation allele at that locus based on prior observations in cancer patients (e.g. from COSMIC), and P(Gₜ|Gₚ), where Gₜ is the genotype of germline variants present in the tumor given Gₚ, the probability of observing a particular genotype at this locus derived from population scale surveys of variation (such as the 1000 genomes project). These probabilities can then be provided as scores for each variant analyzed in the output, recalibrated based on empirical validation or ground truth data using machine learning methods and later used by the analyst to decide appropriate FP/FN thresholds for downstream annotation and clinical reporting.

The other factor to consider is cellularity of the cancer sample, i.e. the proportion of cancer tissue (and hence DNA) included in a biospecimen (e.g. biopsy, plasma, etc.) with respect to normal cells (representing the germline DNA). When the cellularity is low, the probability that a variant is germline can increase and vice versa. To account for this factor, a random variable “U” can be introduced in the Bayesian network, which represents the inverse of the cellularity, i.e. the probability that a sequencing read is from germline cells (a value from 0 to 1). While this value can be provided at analysis, in some instances this value can be inferred from the data by providing a prior estimate. When considering cellularity, two new CDPs can be estimated: P(Aₜ|Rₜ) and P(A_{ct}|R_{ct}). These can be incorporated in the inference of calls by standard Bayesian techniques.

Finally, population calling methods can also be combined with the method and used to improve the detection of germline mutations in the normal tissue (and consequently reducing false positive somatic mutations) by jointly calling with a bank of data from other samples by methods previously described, but applied in the context described here in which jointly calling the germline with the cancer tissue samples.

### Example 3: Lung Cancer Analysis

A patient with lung cancer is studied. A biopsy is performed to extract a tumor tissue and a normal tissue. Further, the patient's blood is collected. The samples (i.e., the tumor tissue, the normal tissue, and the blood) are sequenced by a high throughput sequencer. The sequencer generates a large number of sequences reads. A system disclosed herein compares the sequences across the samples to align the sequences. Further, a reference human genome is used in the alignment process.

After completing the alignment, the genomes of the tumor tissue, the normal tissue, and the blood are created. A sliding window is simultaneously applied to the three genomes. The sliding window covers a same chromosomal locus. Evaluating the sequences within the window across the samples allows a data analysis application to identify putative variants. Uncertainties of the variants are captured by probabilistic models. Based on existing information published in literature or known databases or previously analyzed patients, the likelihood of the somatic variants characterizing a cancer stage is computed. Further, the likelihood of additional variants representing markers of optimal treatment strategies is computed as well. These computed likelihoods let a physician understand better the current status of the patient and design the best health care for the patient.

### Example 4: Somatic Point Mutation/Small Indel Caller

Targeted resequencing of a tumor sample is performed on regions of nucleic acid encompassing about 100 kB, which includes exons of about 129 actionable cancer genes. In some cases, the re-sequenced region also includes intronic regions in order to detect translocations. Average depth of sequencing is about 300× to about 500×, with variance in coverage. Only a few rounds of PCR amplification on DNA libraries are performed. Paired end read lengths are 250 bp for MiSeq or 150 bp for HiSeq. Overlap of paired-end reads is possible for MiSeq long reads. Both strands of a region can be captured independently and then mixed and sequenced. Fragments can have a median size of about 200 to about 300 bp. Off-target reads outside regions of interest are leveraged for sample identification, large deletion/aneuploidy/fusion detection, and genomic scar analysis (a genomic scar can be a genomic aberration with a known origin).

Methods, systems, and computer readable media provided herein can be used when only tumor data is available, e.g., pathology specimens processed as FFPE blocks. Methods, systems, and computer readable media provided herein can be used when only plasma derived cell-free DNA is sequenced. Methods, systems, and computer readable media provided herein can be used when, e.g., sequencing cell-free DNA from plasma and sequencing germline sequence, e.g., buffy coat is isolated from blood and sequenced to represent germline tissue (lymphocytes). Methods, systems, and computer readable media provided herein can be used when tumor and germline samples are available, in addition to cell-free DNA. Germline sequences can be derived from buffy coat or other tissue biopsy.

Methods can involve input of sequence information in FastQ format. Reads can be aligned to a genome assembly with high sensitivity. Alignments are stored as CRAM files or BAM files. Output is VCF (Variant Call Format). Small single nucleotide variants (SNVs), multinucleotide polymorphisms (MNPs), and small indels in regions of interest are specified as BED file. Allele calls are produced without assumption of ploidy (e.g., low frequency in allele counts). For putative somatic mutations, variant allele frequency (VAF) is indicated in VCF. Diploid genotype is not provided. For putative germline mutations, likely diploid genotype is provided. Prior knowledge of common germane variants in a population (static VCF with MAFs (mutation annotation format)) help differentiate germline mutations from somatic mutations. Joint calling of samples of a patient can be performed when available. Joint calling with a bank of “normal” germline samples sequenced with targeted sequencing method described herein (best sample size is determined) when a germline sample from patient is not available. Prior knowledge of recurrent somatic mutations in cancers (e.g., using COSMIC) can be considered to help differentiate somatic mutations. Calls are made at all positions across regions of interest to produce confident reference calls and no-calls (if needed). Compressed reference calls in gVCF output can be performed to limit size of VCF. The following variant scores can be provided: likelihood of being somatic and germline variants. Customized score recalibration based on training data is performed. For tumor and cell-free DNA samples, cellularity measures can be considered if available (inference based on data). Variant calls are provided for off-target regions. One can take into account if paired-end reads overlap if available (MiSeq 250 bp reads) to improve call accuracy.

Molecular barcodes can be detected to identify duplicate fragments and provide error correction. Also, duplicate reads can be used as independent sequencing events and readjust scores based on redundant sequencing.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the disclosure. It is intended that the following claims define the scope of the invention and that methods and structures within the scope of these claims and their equivalents be covered thereby.

1. A computing system comprising:
(a) a processor, and a memory module configured to execute machine readable instructions; and
(b) a data analysis application comprising:
(1) a data receiving module configured to receive sequence reads of nucleic acid molecules from one or more samples of an individual, wherein the sequence reads are generated by a high-throughput sequencing instrument;
(2) a sequence alignment module configured to align the sequence reads with respect to a reference assembly to generate predicted genomic sequences; and
(3) a genomic analysis module configured to (i) identify a putative variant by analyzing jointly and simultaneously the predicted genomic sequences, and (ii) score the putative variant by a probability of being a somatic mutation or a germline variant.

2. (canceled)

3. (canceled)

4. (canceled)

5. (canceled)

6. (canceled)

7. (canceled)

8. (canceled)

9. (canceled)

10. (canceled)

11. The system of claim 1, wherein the scoring the putative variant comprises adjusting the probability based on a machine learning method trained with sets of good calls and bad calls.

12. The system of claim 1, wherein the identifying and scoring the putative variant comprises making an inference at a chromosomal locus.

13. (canceled)

14. The system of claim 12, wherein the making an inference comprises using a statistical inference.

15. The system of claim 12, wherein the making an inference comprises using a Bayesian inference.

16. (canceled)

17. The system of claim 12, wherein the making an inference is based on a prior probability of finding germline and somatic variants.

18. The system of claim 12, wherein the making an inference is based on a set of sequence reads aligned across the chromosomal locus.

19. The system of claim 12, wherein the making an inference is based on an error rate of the high-throughput sequencing instrument.

20. The system of claim 19, wherein the error rate is provided in quality validation for a base call.

21. (canceled)

22. The system of claim 12, wherein the making an inference is based on a process model of cancer clonal evolution.

23. (canceled)

24. (canceled)

25. The system of claim 12, wherein the making an inference is based on prior knowledge of a common polymorphism at the chromosomal locus in one or more reference populations.

26. The system of claim 12, wherein the making an inference is based on prior knowledge of one or more recurrent cancer mutations at the chromosomal locus.

27. The system of claim 12, wherein the making an inference is based on a percentage of cancer cells in a sample containing a cancer.

28. The system of claim 27, wherein the cancer containing sample comprises one or more DNA molecules causing the cancer.

29. The system of claim 28, wherein the cancer containing sample comprises one or more cancerous tissues.

30. (canceled)

31. The system of claim 28, wherein the making an inference comprises describing a set of aligned sequence reads across the chromosomal locus by a probabilistic model.

32. The system of claim 31, wherein the making an inference comprises describing a ploidy at the chromosomal locus by a probabilistic model.

33. The system of claim 32, wherein the making an inference comprises describing a percentage of cancer cells in a sample by a probabilistic model.

34. The system of claim 33, wherein the percentage is described by a binary variable.

35. The system of claim 1, wherein the data analysis application further comprises a module configured to annotate the putative variant with respect to an impact in one or more of the following: one or more coding regions, a predicted damage severity, one or more germline mutations, one or more somatic mutations, one or more mutation-drug interactions, one or more observed mutations in clinical trials, one or more diseases, one or more syndromes, or one or more side effects.

36-123. (canceled)
